(19) United States
(12) Patent Application Publication
(10) Pub. No.: US 2008/0094461 A1
(43) Pub. Date: Apr. 24, 2008

(54) Printing Method, Printing Apparatus, And Printing Paper

(75) Inventors: Hiroshi Terada, Nara (JP); Noriyuki Tajima, Osaka (JP); Kazumasa Hayashi, Hyogo (JP); Terutaka Okamoto, Nara (JP); Hiroaki Miyasoh, Hyogo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/722,624

(22) PCT Filed: Dec. 22, 2005
(86) PCT No.: PCT/JP05/23630

§ 371 Date: Jun. 22, 2007

(30) Foreign Application Priority Data
Dec. 24, 2004 (JP) 2004-372834
Mar. 28, 2005 (JP) 2005-090918

(51) Int. Cl. B41J 2/01

(52) U.S. Cl. 347/104

(57) ABSTRACT

A printing apparatus having almost the same scale and function as printing apparatuses the usable maximum paper size of which is equivalent to A-4 size can print an image on a paper the size of which is larger than A-4 as necessary. A printing mechanism section (101) and a paper feed mechanism section (180) print an image according to printing data on one side of a paper which can be an expansion printing paper folded once or more times and developable after printing. The paper feed mechanism section (180) reverses a paper and feeds the reversed paper to the printing mechanism section (101). By using a printing mode selecting function of a printer driver (410), a predetermined printing mode is selected from printing modes in which the image is printed in different printing forms on the paper. A printing controller (150) for printing the image on the paper controls the operation of the printing mechanism section (101) and the paper feed mechanism section (180) according to the instruction of the selected printing mode, divides the image in a paper expansion printing mode in which the image is printed on both sides of the expansion printing paper, and prints the divided images on both sides of the expansion printing paper.

### TECHNICAL FIELD

The present invention relates to a printing method and printing apparatus that copy a paper document or the like using an ink-jet, electrophotographic, or suchlike recording method, and/or print out electronic data or the like transmitted from a personal computer (PC), digital camera, or the like, and printing paper used therein.

### BACKGROUND ART

Printing apparatuses used in general offices are broadly of two kinds: a printing apparatus in which paper up to A4 or equivalent size can be used (hereinafter referred to as an A4 printer), and a printing apparatus in which paper of A3 or equivalent size can also be used (hereinafter referred to as an A3 printer).

Recently, due to considerations such as paper standardization, such printing apparatuses used in many ordinary offices and so forth have come to use A4 equivalent paper with overwhelming frequency. In Europe and America, in particular, the use of A4 equivalent paper (such as letter-size paper) is predominant. Most of these office printing apparatuses, and A4 printers in particular, are equipped with an automatic double-sided printing function that automatically prints on both sides of the paper (see Patent Document 1, for example).

The present inventors predict that the use of A4 paper will continue to increase, and that in the future A3 paper will rarely be used either at home or in ordinary offices. Another factor behind this prediction, in addition to the above-mentioned standardization of paper size, is the fact that most images are handled as electronic data, and most such electronic data is created on the assumption of A4 size printing for office use, so that A4 size printing can also be expected to be predominant for such electronic data.

However, even if not normally used very much, printing on large-size paper such as A3 may sometimes be necessary when printing a large table, chart, or the like, and there are consequently cases in which an A3 printer is also installed for such purposes.

Meanwhile, with a copying apparatus, the desire to obtain from a small original a printed image larger than is possible with ordinary paper for which paper passage is possible in that copying apparatus has existed since the early days of copiers.

Following the commercialization of technology for printing color images by processing digital image data in the mid-1980's, in particular, many copying apparatuses came to be provided with a “connected-copy enlargement” function for creating large printout (for use as a poster, for example) that cannot be achieved with a normal print operation alone, using the ability to freely manipulate image data. With this method, the original image was divided into a number of images, the divided images were printed at the largest size possible for the copying apparatus and output individually, after which a human operator joined them together to make a big enlarged image. More recently, various image forming methods have been devised and proposed in order to reduce the burden on the human operator in accurately joining up the separately output images by making use of the ease of manipulation of digital images.

Patent Documents 2 and 3 are examples of proposals relating to these connected-copy enlargement functions.

In Patent Document 2, in order to improve ease of handling when pasting together the separately output images, a method of printing the overlap parts to be pasted together was devised, so that the overlap width is clear.

In Patent Document 3, a division and printing method was devised so that image parts to be focused on do not coincide with pasting joins as far as possible, resulting in a clear final image.

Patent Documents 4 and 5 present examples of comparatively recent techniques. In Patent Document 4, printing information indicating the order of pasting-together is printed along with the images, so that relative positioning when matching up images after output is readily perceived.

In Patent Document 5, the image drawing direction is controlled so that borders forming margins (white spaces) when images are output are minimized, enabling the task of trimming unwanted borders when pasting images together to be alleviated.

Having reached the present day via such developments, various proposals continue to be studied for reducing the burden on a human operator as far as possible in the matching-up process when creating a large image by joining together images output individually by means of a connected-copy enlargement function. This indicates how troublesome the task of matching-up after output is, and that a really satisfactory solution has yet to be found.

Meanwhile, methods whereby paper feed problems are eliminated when different kinds of paper are used, and/or a mark is applied to paper to prevent quality degrading when the image quality differs on the front and rear surfaces, are used for OHP sheets and the like in particular. One such example is given in Patent Document 6. In this example, a mark applied to the front edge of an OHP sheet is used to ensure smooth paper feeding according to the paper used. A conventional example in which the front and rear surfaces are distinguished by means of a mark is also disclosed here.

Patent Document 1: Unexamined Japanese Patent Publication No. 2004-315197

Patent Document 2: Unexamined Japanese Patent Publication No. HEI 5-183729

Patent Document 3: Unexamined Japanese Patent Publication No. HEI 6-6520

Patent Document 4: Unexamined Japanese Patent Publication No. 2003-274135

Patent Document 5: Unexamined Japanese Patent Publication No. 2004-325492

Patent Document 6: Unexamined Japanese Patent Publication No. HEI 10-236697

### DISCLOSURE OF INVENTION

### Problems to be Solved by the Invention

In recent years, a mode in which a printer and personal computer are used connected together has become popular, and in this mode, text and images created by the personal computer by means of text or image creation software are often printed.

Although such text or image data is generally created on the assumption that A4 size printing will be used overwhelmingly, as described above, depending on the text there may be cases in which the amount of information is large and large-size printing is required for reasons relating to the convenience of the creation software, cramming-in of information, or the like. In such cases, it is assumed that the user has an implicit desire to perform image printing on paper of the largest possible size (such as A3 size, for example) for the purpose of ensuring visibility, for instance. When the amount of information per image is large, reducing the image to A4 size makes detailed parts difficult to distinguish, while keeping the size large and printing the image on a number of sheets prevents the entire image from being seen at a glance.

With the kind of widely used general-purpose A4 printer indicated in Patent Document 1, the largest paper size that can be used for printing is A4, and printing cannot be performed on larger paper. Therefore, as matters stand at present, a user's options are either to perform reduced-size printing of A3 size image data on A4 paper, sacrificing visibility to some degree in the process, or else to divide up A3 size image data for printing on multiple sheets of A4 size paper to be viewed laid out on a desk top, and in some cases to paste these multiple sheets together for use after being printed out.

With a printing apparatus equipped with comprehensive functions such as used in an office, after division and printing have been performed using the kind of connected-copy enlargement function described in “Background Art” above (also referred to as a “poster printing” function in the case of a printer), these output images can be pasted together for use as a large printout.

That is to say, with current products, a user's above-described implicit desire either is not fully satisfied, or else requires extraordinary effort in order to be satisfied.

Thus, considering the fact that an A3 printer is a more complex and expensive apparatus than an ordinary A4 printer, as well as being bigger and requiring a larger installation area, together with the fact that A4 printing is predominant and opportunities for A3 printing are limited, and taking cost performance into account, many users are reluctant to purchase an A3 printer for use on such infrequent occasions.

In view of this situation, there is a demand for a printing method and printing apparatus that enable, for example, printing on paper larger than A4 in size while using an A4 printer, and printing paper used therein.

It is an object of the present invention to provide a printing method and printing apparatus, and printing paper used therein, that, by means of new idea not previously conceived, enable, for example, printout larger than A4 in size to be obtained easily by means of a simple operation while using an A4 printer, without increasing the user's workload as in the case of connected-copy enlargement according to the prior art. In particular, this reduces the relative necessity of wastefully installing a very rarely used A3 or similar large-size printer, and also contributes to resource savings.

While the present invention uses a mark for simplifying an operation at this time, the mark used in Patent Document 6 is not at all envisaged as being printed on printing paper of a size larger than that for which paper passage is possible, as in the present invention. Naturally, therefore, no consideration is given to the relationship between an image that is printed and a mark, and direct application to the present invention is not possible.

### Means for Solving the Problems

A printing method of the present invention performs image printing using printing paper of a size larger than that for which paper passage is possible for a printing apparatus by having: a step of preparing paper of a size larger than a size for which paper passage is possible for a printing apparatus; a step of folding this large-size paper one or more times to adjust the paper surface, thereby making a paper size for which paper passage is possible for the printing apparatus; a step of inserting the paper that has been made a size for which paper passage is possible and that has a mark in a fixed positional relationship to the fold into the printing apparatus, and printing an image on both folded surfaces thereof; and a step of, after printing on both surfaces, unfolding the folded paper, and restoring it to the original large-size paper.

A printing method of the present invention performs image printing using printing paper of a size larger than that for which paper passage is possible for a printing apparatus by having: a step of preparing paper of a size larger than a size for which paper passage is possible for a printing apparatus; a step of folding this large-size paper one or more times to adjust the paper surface, thereby making a paper size for which paper passage is possible for the printing apparatus; a step of inserting the paper that has been made a size for which paper passage is possible and that has a mark in a fixed positional relationship to the fold into the printing apparatus, and printing an image on both folded surfaces thereof; and a step of, after printing on both surfaces, unfolding the folded paper, and restoring it to the original large-size paper.

### ADVANTAGEOUS EFFECT OF THE INVENTION

According to the present invention, a printing method, printing apparatus, and printing paper used therein can be provided whereby, in a printing apparatus virtually identical in scale and function to a printing apparatus for which the maximum normally usable paper size is small, such as A4, for example, printing can be performed as necessary on paper of a size larger than that maximum paper size.

### BRIEF DESCRIPTION OF DRAWINGS

FIG. 1 is a drawing illustrating extended printing paper according to Embodiment 1 of the present invention;

FIG. 2 is a cross-sectional drawing showing the overall configuration of a printing apparatus according to Embodiment 1 of the present invention;

FIG. 3 is a drawing showing the block configuration of electrical circuitry for a printing system 500 that performs printing by means of a printing apparatus according to Embodiment 1 of the present invention;

FIG. 4 is a drawing showing the half-opened-out state of extended printing paper printed to completion by a printing method or printing apparatus according to Embodiment 1 of the present invention;

FIG. 5 is a drawing showing previously folded extended printing paper used as an A3 image after being printed to completion by a printing method or printing apparatus according to Embodiment 1 of the present invention;

FIG. 6 is a chart illustrating an example of the operation of a printing apparatus according to the present invention when there are a plurality of modes;

FIG. 7 is a cross-sectional drawing showing the overall configuration of a printing apparatus according to Embodiment 2 of the present invention, and shows the state in which extended printing paper is set in the paper feed aperture;

FIG. 8 is a cross-sectional drawing showing the overall configuration of a printing apparatus according to Embodiment 2 of the present invention, and shows the state immediately before extended printing paper is drawn into the apparatus once again after printing of the first surface has finished;

FIG. 9A is a drawing for explaining the character printing method according to Embodiment 3 of the present invention, and shows the printing result when printing is performed normally;

FIG. 9B is a drawing for explaining the character printing method according to Embodiment 3 of the present invention, and shows the printing result when an entire line containing characters is shifted laterally until a space between characters is at the fold;

FIG. 10 is a drawing illustrating extended printing paper according to Embodiment 4 of the present invention;

FIG. 11 is a cross-sectional drawing showing the overall configuration of a printing apparatus according to Embodiment 4 of the present invention;

FIG. 12 is a drawing showing the half-opened-out state of extended printing paper printed to completion by a printing method or printing apparatus according to Embodiment 4 of the present invention;

FIG. 13 is a drawing showing the state of previously folded A3 extended printing paper used as an image after being printed to completion by a printing method or printing apparatus according to Embodiment 4 of the present invention;

FIG. 14 is a cross-sectional drawing showing the overall configuration of a printing apparatus according to Embodiment 5 of the present invention, and shows the state in which extended printing paper is set in the paper feed aperture;

FIG. 15 is a cross-sectional drawing showing the overall configuration of a printing apparatus according to Embodiment 5 of the present invention, and shows the state immediately before extended printing paper is drawn into the apparatus once again after printing of the first surface has finished;

FIG. 16A is a drawing for explaining the character printing method according to Embodiment 6 of the present invention;

FIG. 16B is a drawing for explaining the character printing method according to Embodiment 6 of the present invention;

FIG. 17 is a cross-sectional drawing showing the overall configuration of a printing apparatus according to Embodiment 7 of the present invention;

FIG. 18 is a drawing illustrating extended printing paper according to Embodiment 7 of the present invention; and

FIG. 19 is a drawing illustrating A2 extended printing paper for obtaining A2 size printout according to Embodiment 7 of the present invention.

### BEST MODE FOR CARRYING OUT THE INVENTION

Embodiments of the present invention will now be described in detail with reference to the accompanying drawings.

### Embodiment 1

(Description of Extended Printing Paper)

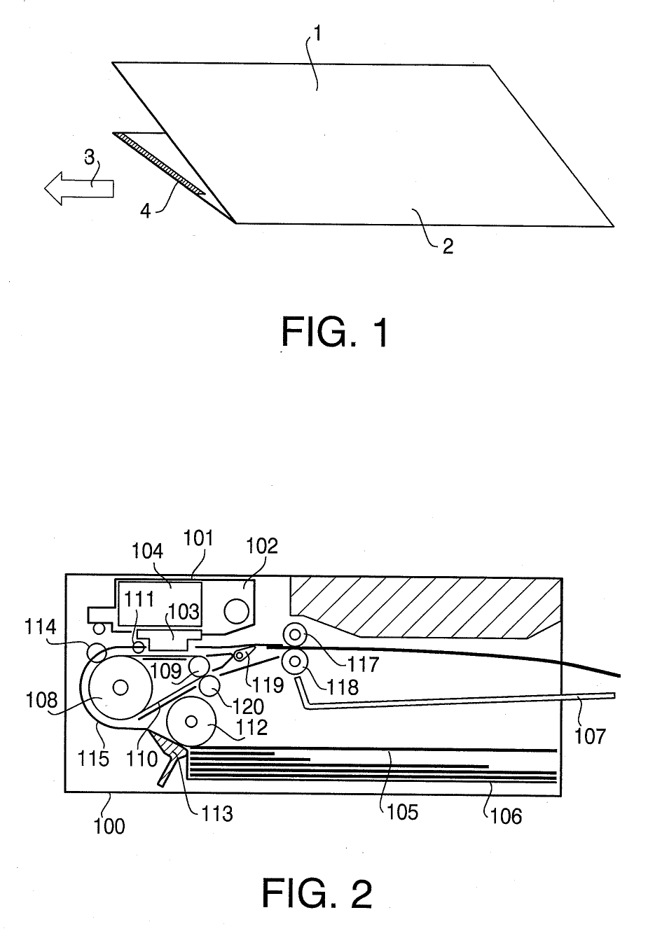

FIG. 1 shows an example of printing paper that is desirable for use in a printing method or printing apparatus according to Embodiment 1 of the present invention (hereinafter referred to as “extended printing paper”). This extended printing paper is an A3 size sheet of paper 1 folded in the middle, creating a fold 2.

Folded in half, this extended printing paper is inserted into a printing apparatus described later herein in the direction indicated by the arrow 3, and in Embodiment 1 an adhesive layer 4 is preferably provided on part of a folded inner surface. This adhesive layer enables the upper and lower parts to be kept in close contact in the folded state, and to be handled just like a single sheet of paper inside the apparatus.

Although this adhesive layer is firm with respect to shearing force, it can easily be peeled off depending on the pulling direction. A water-based acrylic adhesive or the like, for example, can be used as such an adhesive material.

It is furthermore desirable for a configuration to be used such that pressure is applied beforehand to the adhesive layer by means of a rubber adhesive to cause adhesion, and once peeling-off is performed the adhesive effect is mostly lost, so that after printing the paper can be handled in the same way as A3 paper by opening it out. Also, this adhesive layer 4 may be applied to an entire inner surface if its adhesive strength is very weak. In particular, while a printing apparatus using an ink-jet recording method described later herein is described by way of example in Embodiment 1, if an electrophotographic type of printing apparatus is used, wrinkles are prone to occur in a fixing section that heat-fixes toner, and therefore it is desirable for the area of this adhesive layer to be large.

In FIG. 1 of this sample implementation, the edges of adhesive layer 4 are shown as being formed so as to coincide with the vertical and horizontal edges of paper 1, but in actuality it is desirable for a minute uncoated area of adhesive layer 4 to be provided at the edges. If adhesive layer 4 is provided up to the edges of paper 1, there is a possibility of adhesive being extruded due to pressure from a roller or the like during transportation inside the apparatus and adhering to members inside the apparatus, with detrimental results. When an electrophotographic printing apparatus is used, in particular, since high pressure is applied while also applying heat in the fixing unit in order to fix an image, there is a high probability of adhesive being extruded and adversely affecting members of the apparatus.

(Description of Printing Apparatus)

FIG. 2 is a cross-sectional side view of a printing apparatus according to Embodiment 1 of the present invention.

This printing apparatus 100 can normally use printing paper up to A4 in size and uses an ink-jet recording method, and is provided with an automatic double-side mechanism that enables double-sided printing by reversing paper inside the apparatus. An internal print mechanism section 101 comprises a carriage 102 that is movable in the main scanning direction (the paper surface depth wise direction in FIG. 2), a recording head 103 constituting the ink-jet head mounted on the carriage, an ink cartridge 104 that supplies ink to the recording head, and so forth.

Below, a paper feed cassette 106 that can hold many sheets of paper 105 can be freely inserted and removed from the front (the right-hand direction in FIG. 2). The apparatus draws in paper 105 fed from paper feed cassette 106, and after recording a predetermined image by means of print mechanism section 101, ejects paper 105 onto an ejection tray 107 provided above paper feed cassette 106.

In order to transport paper 105 in a sub-scan direction with respect to main scanning of recording head 103 in print mechanism section 101, a transport belt 110 that transports paper 105 by means of electrostatic adhesion is suspended between a first transport roller 108 and a second transport roller 109.

A front edge roller 111 that regulates the angle of transportation of paper 105 is located so as to press against first transport roller 108 via transport belt 110.

In order to feed paper 105 from paper feed cassette 106 onto transport belt 110, a paper feed roller 112 and a friction pad 113 that are pressed against each other are provided to separate and feed one sheet of paper 105 at a time, an intermediate roller 114 is provided that presses fed paper 105 against first transport roller 108, and a guide member 115 that guides paper 105 is also provided.

In order to eject paper 105 for which printing has finished onto ejection tray 107, a guide member 116 that guides paper 105, an upper ejection roller 117, and a lower ejection roller 118, are provided.

As mechanisms for performing automatic double-sided printing, a guide lug 119 and reverse intermediate roller 120 are provided that, in order for paper 105 ejected by upper and lower ejection rollers 117 and 118 after printing of its surface until its rear edge is left to be drawn back again by the reversal of upper and lower ejection rollers 117 and 118, guide drawn-back paper 105 downward. These mechanisms make it possible for paper 105 to be reversed and undergo automatic double-sided printing.

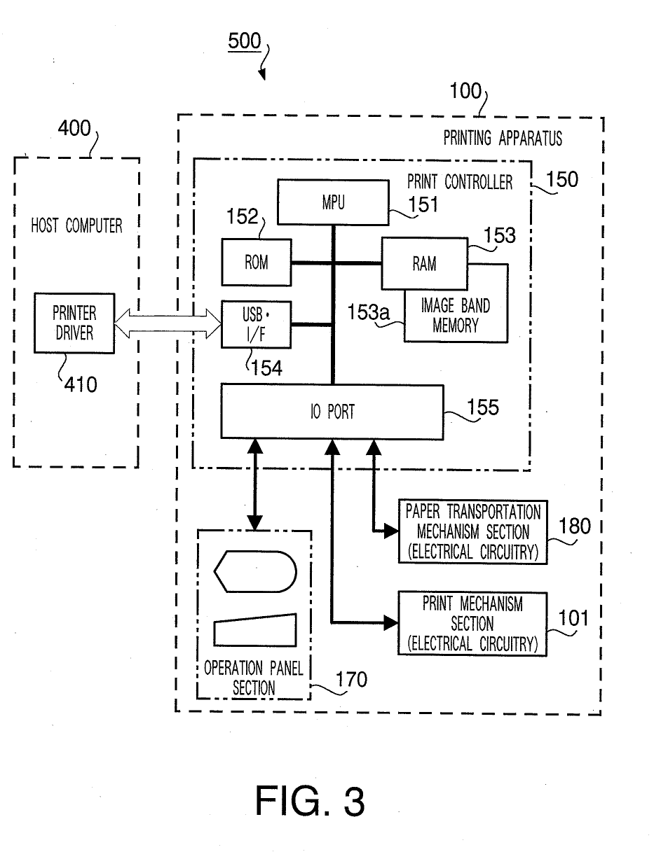

FIG. 3 shows the block configuration of electrical circuitry for a printing system 500 that performs printing by means of printing apparatus 100 according to the present invention.

In FIG. 3, a host computer (also referred to simply as “computer”) 400 is an information processing apparatus in printing system 500, and a so-called personal computer or the like is used as this host computer 400.

A printer driver 410, which is software included as part of a program of host computer 400, drives printing apparatus 100 as a device (peripheral apparatus) in the host computer system. Printer driver 410 allows setting of information regarding an operating condition of printing apparatus 100, and print data (including control data that directs apparatus operation or the like as well as image data) can be generated and sent out under the set operating condition, causing printing apparatus 100 to perform image printing or the like.

Printer driver 410 has a function (called a print mode selection function) that enables selection by means of a user operation or the like of a print mode determining how an image (image, text, or the like) based on print data to be printed (here, an image to be printed based on print data is also referred to simply as “data”) is to be printed by printing apparatus 100 via a display apparatus or input apparatus (keyboard or the like) of host computer 400. A print mode is a mode of printing in which an image based on print data that is printed on paper differs.

For example, the print mode selection function may be such as to select a page division print mode in which data larger than paper is divided, and printed in divided fashion on paper smaller than that data; a paper extension print mode in which data larger than paper passed through printing apparatus 100 is printed using extended printing paper; a normal print mode in which data is printed on one side of paper such as ordinary paper; a double-sided print mode in which data is printed on both sides; reduced print mode in which data is reduced before printing on paper; and so forth.

At this time, information as to which print mode has been selected is sent out to printing apparatus 100, included in part of the print data as control data.

As shown in FIG. 3, in addition to print mechanism section 101, printing apparatus 100 also has a print controller (also referred to simply as “controller”) 150, an operation panel 170, and a paper transportation mechanism section 180.

The print controller 150 (control section, information processing section), has a general so-called computer structure, comprising an MPU (microprocessor) 151, ROM (read-only memory) 152, RAM (writable memory) 153, a USB I/F (Universal Serial Bus interface) 154, an I/O port (input/output port) 155, and so forth. In other words, print controller 150 controls the operation of paper transportation mechanism section 180 and print mechanism section 101 and prints an image based on image data in a predetermined print mode among a plurality of print modes as modes of printing in which an image based on print data that is printed on paper differs.

MPU 151 performs digital data processing in accordance with program code separately written into ROM 152 beforehand, and performs input of input data from host computer 400, generation of bit-mapped image data for printing based on that image data, printing of a bit-mapped image by means of recording head 103 (see FIG. 2) using that data, and so forth, described later herein.

Program code written into ROM 152 includes, for example, code for performing printing in accordance with print data input from host computer 400, and causes the operation of elements in printing apparatus 100 via print controller 150. To be specific, ROM 152 has program code of a page division print mode in which data larger than paper is divided and printed in divided fashion on paper smaller than that data, and a paper extension print mode in which data larger than paper passed through printing apparatus 100 is printed using extended printing paper. In addition to paper extension print mode, ROM 152 may also have program code of a normal print mode in which data is printed on one side of paper, a double-sided print mode in which data is printed on both sides, a reduced print mode in which data is reduced before printing on paper, and so forth.

A print mode that determines how an image based on print data is printed is selected by means of the above-described print mode selection function of printer driver 410 in host computer 400, and information as to which print mode has been selected is input to print controller 150 as control data. Then print controller 150 determines the print mode based on that control data, and performs printing of an image based on print data in accordance with a program corresponding to the determined print mode.

At the time of digital data processing by MPU 151 in accordance with program code separately written into ROM 152 beforehand, RAM 153 performs temporary storage of data in that processing. In part of this RAM 153 there is configured image band memory 153a that temporarily stores bit-mapped image data for printing that is generated based on print data from host computer 400, described later herein.

USB I/F (Universal Serial Bus interface) 154 is an interface circuit for use by printing apparatus 100 to perform data communication with host computer 400.

Via this USB I/F 154, print controller 150 receives print data transmitted from host computer 400, and transmits the printing apparatus 100 control status and so forth to host computer 400.

I/O port 155 performs input/output of signals for use by print controller 150 to control manipulation and display operations of operation panel section 170 in printing apparatus 100, and the operation of paper transportation mechanism section 180, print mechanism section 101, and other mechanisms.

Operation panel section 170 has input key switches for inputting a command for a user performing a printing apparatus 100 operation, and a display panel for displaying information.

Paper transportation mechanism section 180 comprising transport rollers (108 and 109), transport belt 110, ejection rollers (117 and 118), and so forth, performs feeding of paper 105 from paper feed cassette 106, transportation to print mechanism section 101, and ejection onto ejection tray 107.

By means of signals via I/O port 155, print controller 150 controls operating mechanism application/relaxation/disengagement for friction pad 113 for the movement of paper in paper transportation mechanism section 180, and also controls the pressure between friction pad 113 and paper feed roller 112.

Also, by means of a signal from I/O port 155, print mechanism section 101 equipped with recording head 103 is provided with bit-mapped image data to be printed by recording head 103 and control data for a print operation of that recording head 103, and prints an image in accordance with print data transmitted from host computer 400 on the surface of paper 105.

As described above, with printer driver 410 (software), a user performing printing can, by this means, set a printing apparatus 100 operating condition in host computer 400, and can generate and output to printing apparatus 100 print data for performing image printing under that set condition.

With regard to print controller 150, MPU 151 operates paper transportation mechanism section 180, print mechanism section 101, and so forth, by means of ROM 152, RAM 153, and so forth, based on an acquired print mode in accordance with program code separately written into ROM 152 beforehand, and can perform control of data processing and mechanisms for printing in printing apparatus 100.

Print controller 150 can divide a bit-mapped image generated based on input print data into halves in a lengthwise direction, select either thereof, and provide that image data to recording head 103, and also has a function that performs double-sided printing by controlling a mechanism for double-sided printing, with the user being able to set the orientation and order of images with respect to the front and rear surfaces of printing paper.

(Description of Paper Extension Print Operation)

Next, an operation will be described for automatically performing printing on A3 size paper (hereinafter referred to as “paper extension printing”) using extended printing paper 1 and printing apparatus 100.

When performing paper extension printing, the user sets extended printing paper 1 in paper feed cassette 106 of printing apparatus 100 in FIG. 2 so that the direction of arrow 3 in FIG. 1 is at the front edge, and performs setting for making a print operating condition paper extension printing (this print condition being called paper extension print mode) in printer driver 410 (see FIG. 3) in a computer (for example, host computer 400 shown in FIG. 3) connected to printing apparatus 100. At this time, an A3 size setting is made as the printing size for which printing is to be performed.

Then the computer (for example, host computer 400 shown in FIG. 3) generates print data for an image for which A3 size printing is to be performed, and outputs this to printing apparatus 100 with a paper extension print command included. In printing apparatus 100, that print data is input by print controller 150 and temporarily stored in RAM 153, the print data is interpreted, and by means of the paper extension print command contained in the print data, control by means of paper extension print mode is set, and bit-mapped image data for printing based on the print data is generated and placed in image band memory 153a.

When bit-mapped image data for printing can be prepared by placement in image band memory 153a of RAM 153 in this way, operation is started by print controller 150 in printing apparatus 100, and one sheet of extended printing paper 1 is transported toward transport belt 110 through the agency of paper feed roller 112 and friction pad 113. At this time, extended printing paper 1 is in a state of being folded in half upon itself, and its edges are stuck together with adhesive, thereby having strong adhesive strength with respect to shearing force, so that it is transported just like a single sheet.

In paper extension print mode, print controller 150 may control the pressure between paper feed roller 112 and friction pad 113 so as to be less than usual. At this time, the adhesive strength of adhesive layer 4 of extended printing paper 1 can be further reduced.

That is to say, in paper extension print mode, print controller 150 controls the pressure between paper feed roller 112 and friction pad 113 so as to be at a level at which folded extended printing paper is passed through as-is as a single sheet of paper (without further manipulating the overlap itself due to folding of the folded paper).

To be specific, print controller 150 controls friction pad 113 to keep extended printing paper handled by friction pad 113 and paper feed roller 112 at the thickness of the overlapping paper constituting the extended printing paper, and feeds the overlapping paper as-is onto transport belt 110 as a single sheet of extended printing paper. That is to say, print controller 150 outputs an operation command to paper transportation mechanism section 180, and paper transportation mechanism section 180 makes the pressure of friction pad 113 on paper feed roller 112 less than its is when handling a sheet of ordinary paper.

For example, when extended printing paper is A3 size paper 1 folded in the middle, creating a fold 2, the pressure is at a level that enables the two overlapping halves of the extended printing paper to be passed through as they are, and is less than the pressure when one sheet of paper is separated and fed at a time.

When A2 paper folded upon itself along the middle and along lines parallel to the vertical and horizontal so as to be of A4 size is used as extended printing paper, print controller 150 sets the pressure between friction pad 113 and paper feed roller 112 to a level at which four sheets of paper opened out to A2 size are transported as they are onto transport belt 110. The pressure at this time is naturally less than the pressure when one sheet of paper 105 is separated and fed at a time, and, here, is the pressure for transporting four sheets without their being separated.

Paper feed cassette 106 may be replaced by a cassette specifically for paper extension printing that holds only one sheet of extended printing paper at a time, in which case print controller 150 may perform control so that this friction pad 113 is disengaged and does not perform any action.

Extended printing paper 1 is transported by transport belt 110, and on reaching print mechanism section 101, one side of extended printing paper 1 is first printed. Here, since extended printing paper 1 is paper (paper 105) that has been set with the above-described orientation in paper feed cassette 106, the position of its fold 2 is identified. Thus, print controller 150 halves lengthwise an A3 size image to be printed, and then prints it without leaving a print margin at the edge of fold 2 on the paper surface that has become of A4 size as a result of A3 size paper 1 being folded in half.

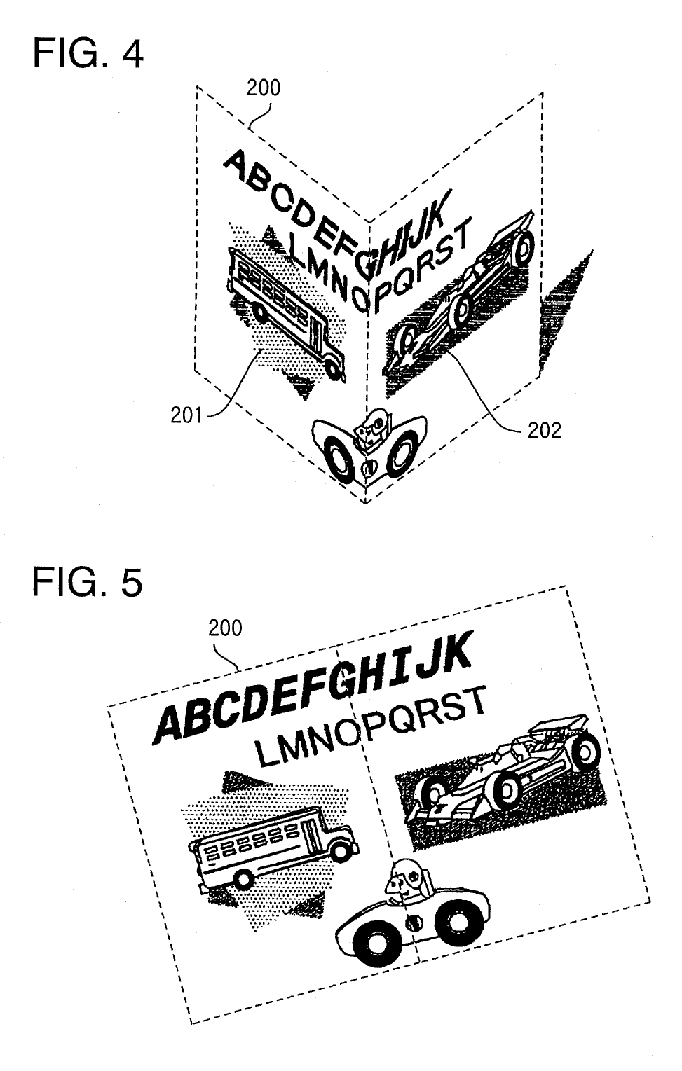

FIG. 4 shows the half-opened-out state of extended printing paper 200 on which both sides have been printed to completion. In the first printing, the image on the first surface—that is, surface 201 in FIG. 4—is printed first. At this time, in the printing of surface 201, printing is performed in order from the front edge (from the upper part of FIG. 4) by main scanning of recording head 103 and sub-scan direction transportation of extended printing paper 1 synchronized therewith.

Returning to FIG. 2 again, the front edge of extended printing paper 1 whose first surface has been printed is transported in the sub-scan direction, and reaches guide lug 119. As guide lug 119 is only lightly sprung in an anticlockwise direction about its rotation axis, the front edge of extended printing paper 1 pushes this guide lug aside and reaches upper and lower ejection rollers 117 and 118, and driven by the rotation of these rollers, further proceeds toward the ejection tray.

When the first surface has been completely printed, and the rear edge of extended printing paper 1 has been transported as far as the vicinity of upper and lower ejection rollers 117 and 118, upper and lower ejection rollers 117 and 118 start reversing, and extended printing paper 1 is transported again in the direction of transport belt 110. Since guide lug 119 is in the position shown in FIG. 2 at this time, extended printing paper 1 enters the lower path, and is again transported, driven by transport belt 110 and reverse intermediate roller 120.

What is printed by print mechanism section 101 at this time is the second surface of extended printing paper 1—that is, surface 202 in FIG. 4. The lateral-direction positions of the images printed on the respective surfaces are controlled by print controller 150 so as to be connected at the fold. That is to say, print controller 150 prints the remaining lengthwise-direction half of the A3 size image to be printed on surface 202 without leaving a print margin at the edge of fold 2.

Printing of the second surface is performed from the rear edge (from the lower part of FIG. 4). Therefore, the image printing start position from the edge of extended printing paper 1 is controlled by print controller 150 so that the images printed on the respective surfaces are connected at the fold. That is to say, in printing on surface 202, print controller 150 calculates the printing start position so that the orientation of the printed image is the same for surface 201 and surface 202, and sends bit-mapped image data generated by interpreting a print command to recording head 103 in order from a position corresponding to the rear edge of the paper (the lower part in FIG. 4) to a position corresponding to the front edge (the upper part in FIG. 4).

FIG. 5 shows previously folded extended printing paper 200 opened out and used as an A3 image after being printed to completion.

This concludes a description of an operation for automatically performing printing on A3 paper (in paper extension print mode) using extended printing paper 1 and printing apparatus 100.

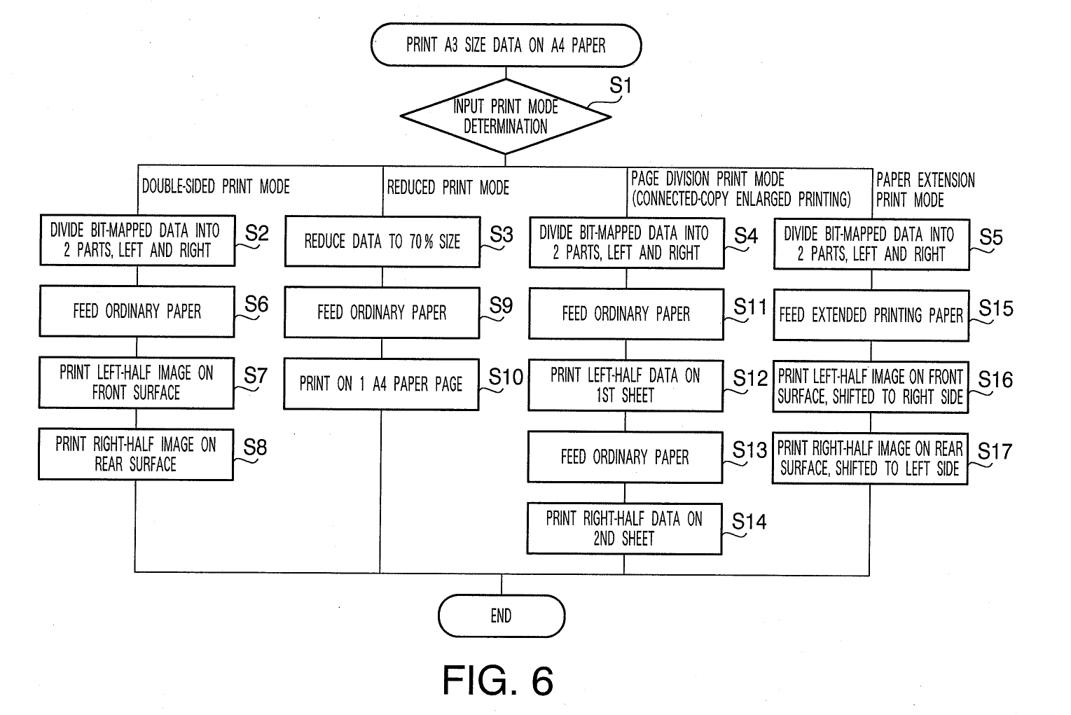

FIG. 6 illustrates an example of the operation of printing apparatus 100 according to the present invention having a plurality of modes in addition to paper extension print mode, being a flowchart that shows processing when data of a size larger than a size for which paper passage is possible in printing apparatus 100 is printed on paper of a size for which paper passage is possible. As described above, printing apparatus 100 has a plurality of print modes, and FIG. 6 shows the processing of print modes other than a general normal print mode, such as modes for printing data corresponding to the paper size on one side of passed-through paper, or printing reduced or enlarged data on paper.

As mentioned before, these print modes are implemented by print controller 150 in accordance with program code corresponding to each print mode written in ROM 152. In this way, print controller 150 can print data of a size larger than that for which paper passage is possible in printing apparatus 100 on paper of a size for which paper passage is possible. With this printing apparatus 100, if data of a size larger than data corresponding to a size for which paper passage is possible is printed on paper of a size for which paper passage is possible, the size of data printed and the paper size may be any size. Here, for convenience, a case will be described in which A3 size data (here, bit-mapped data) is printed on A4 paper.

In printing apparatus 100, in step S1 a selection is made by the print mode selection function of printer driver 410 and is input to print controller 150, the selected print mode is determined by means of information as to which print mode has been selected (control data), the processing flow proceeds to the selected print mode processing (one of step S2 through step S5), and the relevant print mode processing is performed.

If double-sided print mode is selected, the processing flow proceeds to step S2, a bit-mapped image comprising A3 size data that is print data is divided into left and right parts, and the processing flow proceeds to step S6.

In step S6, print controller 150 feeds ordinary paper (here, A4 size recording paper) via paper transportation mechanism section 180, and proceeds to step S7.

In step S7, print controller 150 prints the left-half image of the divided bit-mapped image on the front surface of the fed recording paper (paper) via print mechanism section 101, and proceeds to step S8.

In step S8, print controller 150 prints the right-half image of the divided bit-mapped image on the rear surface of the fed recording paper via print mechanism section 101, and terminates double-sided print mode.

If the print mode is determined to be reduced print mode in step S1, the processing flow proceeds to step S3, and in step S3 a bit-mapped image comprising A3 size data that is print data is reduced to a size corresponding to the paper to be printed—here, 70% size—and the processing flow proceeds to step S9.

In step S9, print controller 150 feeds ordinary paper (here, A4 size paper) via paper transportation mechanism section 180, and proceeds to step S10.

In step S10, print controller 150 prints the reduced data on the front surface (1 page) of ordinary paper—here, A4 size paper—and terminates reduced print mode.

If the print mode is determined to be page division (connected-copy enlargement) print mode in step S1, the processing flow proceeds to step S4.

In step S4, print controller 150 divides a bit-mapped image comprising A3 size data that is print data into left and right parts, and proceeds to step S11.

In step S11, print controller 150 feeds ordinary paper (here, A4 size recording paper) via paper transportation mechanism section 180, and proceeds to step S12.

In step S12, print controller 150 prints the left-half image of the divided bit-mapped image on the front surface of the fed recording paper (paper) via print mechanism section 101, and proceeds to step S13.

In step S13, print controller 150 feeds ordinary paper (here, A4 size recording paper) as the second sheet of paper to be printed via paper transportation mechanism section 180, and proceeds to step S14.

In step S14, print controller 150 prints the right-half image of the divided bit-mapped image on the front surface of the fed second sheet of ordinary paper via print mechanism section 101, and terminates page division print mode. Then, by joining up the first and second sheets, data of a size larger than that for which paper passage is possible in printing apparatus 100 can be output as printed paper of a size larger than that for which paper passage is possible.

If the print mode is determined to be paper extension print mode in step S1, the processing flow proceeds to step S5, and in step S5 print controller 150 divides a bit-mapped image comprising A3 size data that is print data into left and right parts, and proceeds to step S15.

In step S15, print controller 150 feeds extended printing paper (here, paper made A4 size by folding A3 size recording paper) via paper transportation mechanism section 180, and proceeds to step S16.

In step S16, print controller 150 prints the left-half image of the divided bit-mapped image on the front surface of the fed extended printing paper, shifted to one side—here, the right side—via print mechanism section 101. More specifically, in step S16 divided image data is shifted so as to be in a position at which its line of division coincides with the edge of one side on the front surface of the extended printing paper—that is, the edge that forms the fold of the extended printing paper—before being printed on the front surface of the extended printing paper. After this step S16 processing, the processing flow proceeds to step S17.

In step S17, print controller 150, via paper transportation mechanism section 180, reverses the right-half image of the divided bit-mapped image by means of print mechanism section 101, prints it on the rear surface of the extended printing paper made the side to be printed, shifted to one side—here the left side—and terminates paper extension print mode. More specifically, in step S17 divided image data is shifted so as to be in a position at which its line of division coincides with the edge of one side on the rear surface of the extended printing paper—that is, the edge that forms the fold of the extended printing paper—before being printed on the rear surface of the extended printing paper. Then the extended printing paper is opened out by peeling off the inner-surface tack of the extended printing paper printed on both the front surface and rear surface.

Above, a printing apparatus 100 has been described that has a paper extension print mode that is a print mode in which printing is performed automatically on A3 paper using extended printing paper 1.

Printing apparatus 100 may be provided with a guide in the paper transportation path that is maintained stably with respect to the location and direction of the paper 105 sub-scan direction edge, so that, during paper transportation, the direction of extended printing paper 1 used as paper can be corrected by bringing the edge of fold 2 of extended printing paper 1 into contact with this guide. By this means, the occurrence of a gap or drop in the position of fold 2 in the extended printing paper 1 main scanning direction raster can be further suppressed.

Furthermore, in printing apparatus 100, recording head 103 may be provided with a photosensor that detects the position of the front (edge) of paper 105 on which printing is to be performed, and this photosensor may detect the front (edge) of paper 105, and print controller 150 may adjust the timing for sending data of an image to be printed with respect to the main scanning direction position of recording head 103. By this means, the occurrence of a gap or drop in the position of fold 2 in the extended printing paper 1 main scanning direction raster can be almost surely eliminated.

In the above description, it has been assumed that print controller 150 prints at the edges of fold 2 on paper surfaces 201 and 202 into which paper 1 is folded without leaving a print margin, but, for example, printing may also be performed leaving a print margin of around 0.5 mm, and furthermore, that margin part need not be a white space, but may be an image extended by continuing pixels of the same color and density as pixels near the margin for each raster (that is, with the printed image extended to the fold 2 area). By performing this kind of image processing, when fold 2 is opened out, a slight uplift of that part enables visible image distortion to be corrected or suppressed.

Also, in the above description, the size of a page on which printing is performed (one surface constituting the range subject to printing) is assumed to be larger than the size of the paper surface on which that printing is actually performed, and, for example, it has been assumed that printing is performed on both paper surfaces of A4 size formed by folding A3 size paper in half, but, for example, in a case in which an A4 size image is enlarged twofold and printed, that enlarged image may be divided in two, and one of those divisions may be printed on the front surface of the printing paper while the other is printed on the rear surface of the same printing paper.

### Embodiment 2

Next, a description will be given of printing paper, a printing method, and a printing apparatus according to Embodiment 2 of the present invention. In the following description, descriptions of parts having the same configuration or performing the same operation as in Embodiment 1 are omitted, and elements having the same function are assigned the same reference numbers.

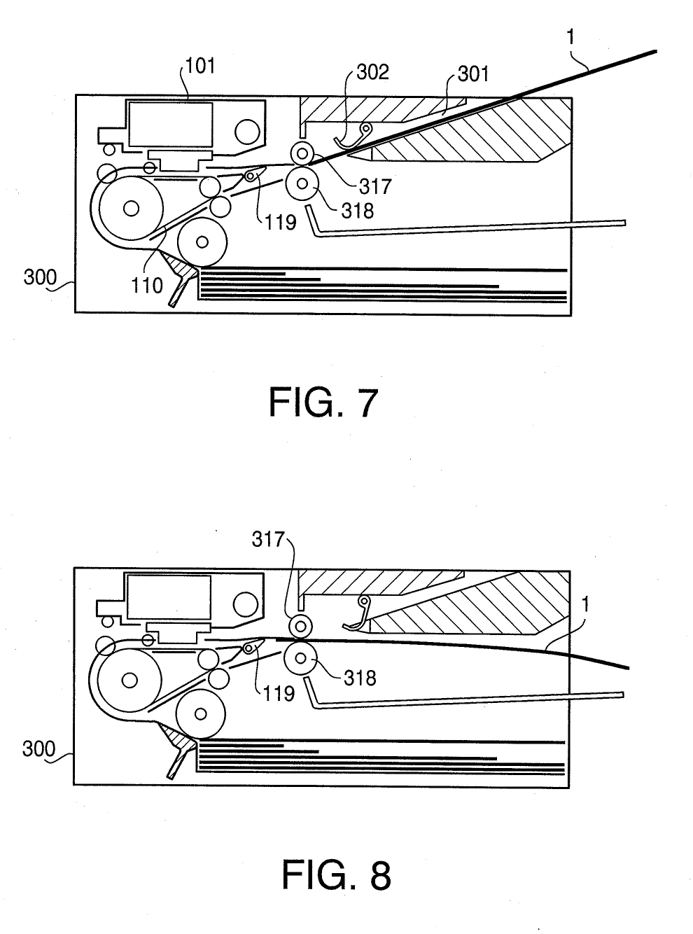

FIG. 7 and FIG. 8 are cross-sectional side views of a printing apparatus according to Embodiment 2 of the present invention. In this embodiment, a printing apparatus 300 is equipped with a special paper feed aperture 301 for extended printing paper 1, for paper extension printing.

When performing paper extension printing, the user sets extended printing paper 1 in special paper feed aperture 301 as shown in FIG. 7 so that the front edge comes up against upper and lower ejection rollers 317 and 318. The direction in which extended printing paper 1 is set at this time is the same as in Embodiment 1. Lower ejection roller 318 has a larger diameter than upper ejection roller 317 so that the front edge of extended printing paper 1 tends to hit it, and extended printing paper 1 is readily drawn in by its subsequent rotation. A detection lever 302 is located at the rear of special paper feed aperture 301, and when extended printing paper 1 is set as shown in FIG. 7, the fact that extended printing paper 1 is set is detected by a paper presence sensor (not shown) linked to detection lever 302, and printing apparatus 300 enters paper extension print mode.

When a print command is issued from a computer (not shown) connected to this printing apparatus in this state, a paper extension print operation starts.

First, upper and lower ejection rollers 317 and 318 start rotating in a direction such that extended printing paper 1 is drawn into the apparatus, and extended printing paper 1 is drawn in. At this time, since upper and lower ejection rollers 317 and 318 have no function for handling paper one sheet at a time as with the normal paper feed section below, there is no obstruction to transportation even if the adhesive strength of adhesive on the folded inner surfaces of extended printing paper 1 is extremely weak, or even if no adhesive layer is provided.

The front edge of drawn-in extended printing paper 1 is guided by upward-sprung guide lug 119 in the same way as in Embodiment 1 and enters the lower path, and is transported to print mechanism section 101 by transport belt 110 and the same kind of peripheral members as in Embodiment 1, where the first surface is printed. The operations after printing are the same as in Embodiment 1.

FIG. 8 shows the state in which printing of the first surface has finished, and the front edge of extended printing paper 1 has reached the vicinity of upper and lower ejection rollers 317 and 318. At this time, upper and lower ejection rollers 317 and 318 start reversing, extended printing paper 1 is drawn into the apparatus once again, and printing of the second surface is performed in the same way as in Embodiment 1.

This concludes a description of printing paper, a printing method, and a printing apparatus according to Embodiment 2 of the present invention. In Embodiment 2, a paper feed aperture specifically for paper extension printing is provided, so that a mechanism for single sheet separation is not necessary in the paper feed section, and therefore an adhesive layer of a folded part of extended printing paper 1 is unnecessary, or may be of extremely weak adhesive strength.

### Embodiment 3

Next, a description will be given of a printing method and printing apparatus according to Embodiment 3 of the present invention. In Embodiment 3, when a small character, specifically, lies on the fold of extended printing paper 1, control is performed so that printing is performed with the character position shifted. That is to say, in this embodiment, print controller 150 has an object adjustment section that adjusts the position of objects on a page, and by means of this object adjustment section the position of a character lying on the fold of extended printing paper 1 can be shifted so as not to lie on the fold before being printed.

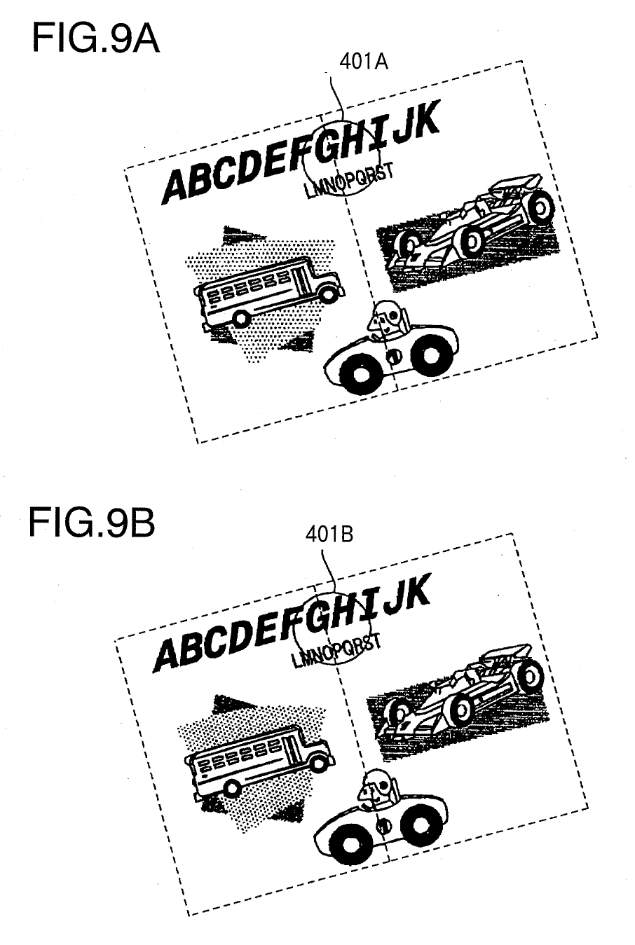

FIG. 9A shows a result of printing when normal printing is performed without performing this kind of control. In the area denoted by reference code 401A, even though a large character in the upper line lies on the fold, this is not much of a problem, whereas a small character in the lower line lying on the fold may be difficult to distinguish and misread.

In Embodiment 3, if a character of a predetermined size or smaller is positioned on the fold in normal printing, control is performed so that the entire line containing that character is shifted sideways until a space between characters lies on the fold, as shown in the area denoted by reference code 401B in FIG. 9B, before printing is performed. This can be done by having print controller 150, when interpreting the character code of a character to be printed and placing a bit-mapped image of that font in image band memory 153a, determine whether or not that placement position impinges upon the position of fold 2, and if so, correcting the placement position of that bit-mapped image for the relevant character string so that fold 2 is between two characters. Instead of shifting the entire line, nearby character spacing may be adjusted little by little so that the character in question is moved away from the fold.

If an image rather than a character impinges upon fold 2, variation of image density in an area of that image near where it impinges upon fold 2 can be checked, and the position of that image finely adjusted so that an area without that variation, or with smaller variation, is positioned at fold 2. This fine adjustment of position can be performed for each object of an image in print data.

This concludes a description of a printing method and printing apparatus according to Embodiment 3 of the present invention.

With Embodiment 3, when extended printing paper 1 is opened out and viewed in its entirety after printing, small characters, specifically, are clearly visible since they do not lie on the fold, and misidentification of characters can be prevented.

In Embodiment 3, an example has been described in which, when a small character lies on the fold, its position is shifted away from the fold so that there is no interference with character recognition. In other situations in which printing becomes unstable due to overlapping of the fold, other than by a character, such as in the case of dots or ruled lines in the vicinity of the fold, the same kind of effect is produced by execution as necessary. In particular, if vertical ruled lines are near the fold and are left as they are, there may be a tendency for ruled lines not to be printed or to be discontinuous due to a minute positional displacement or the like.

In the above embodiments, descriptions have centered on examples in which double-sided printing is performed using an ink-jet type of printing apparatus, but the present invention can also achieve the same kind of effects when using a printing apparatus that has an automatic double-sided printing function employing an electrophotographic recording method.

In this case, with regard to the sub-scan direction print positions on the front and rear surfaces of paper, a photosensor, for example, for detecting the front edge of paper in the sub-scan direction may be provided between the location of a roller for delaying paper before a toner image is transferred to the paper (a so-called registration roller) and the location at which transfer is performed, and the front edge of the paper and the front edge of the print area in the toner image may be made to coincide at the location at which transfer is performed by adjusting the speed of paper transportation according to the relationship between the time of detection of the front edge of the paper by the photosensor and the position of the front edge of the print area in the toner image. By this means, the sub-scan direction print positions on the front and rear surfaces of the paper are aligned more accurately, and misalignment between an image printed on surface 201 and an image printed on surface 202 can be further suppressed.

In this embodiment, it has been assumed that, in order to prevent printing of a character or image from impinging upon fold 2 of extended printing paper 1, print controller 150 of printing apparatus 100 corrects the placement position of a bit-mapped image for a character or image, but that position correction may also be performed by printer driver 410.

That is to say, when, for example, printer driver 410 performs printing by printing apparatus 100 in paper extension print mode, when generating bit-mapped image data for printing, printer driver 410 corrects the bit-mapped image placement position for that character or image so that the character or image does not impinge upon fold 2 of extended printing paper 1. Then printer driver 410 sends that generated data to printing apparatus 100 and causes printing apparatus 100 to print that data. Printing apparatus 100 performs printing without leaving a print margin at the fold 2 edge of surface 201 and surface 202.

By using this kind of configuration, printer driver 410 can display on the host computer, as a so-called print preview, an image in which the position of a character or image has been corrected so as not to impinge upon fold 2, and the user can also carry out a check before executing printing. At this time, by further having printer driver 410 enable the user to adjust the object (character or image object), amount, and so forth of correction of the placement position of a bit-mapped image, the user can perform optimal adjustment according to the purpose of use.

In addition to having a paper extension print mode function, printing apparatus 100 (print controller 150) may divide bit-mapped image data generated based on input image data into halves in the lengthwise direction, and print one half on the front surface of paper 105 and the other half on the rear surface, leaving a normal print margin on each (this print operating condition being called page division print mode). Furthermore, printing apparatus 100 may perform actual printing on a paper surface smaller than the size of a page on which printing is performed (one surface constituting the range subject to printing) (this print operating condition being called reduced print mode). Moreover, printing apparatus 100 may have a function for performing double-sided printing by controlling a mechanism for double-sided printing (this print operating condition being called automatic double-sided print mode). Accordingly, printer driver 410 may, in the same way as for paper extension print mode, make a selection for page division print mode, reduced print mode, and automatic double-sided print mode, and enable print operating condition setting to be performed in the relevant mode.

In the above embodiments, descriptions have centered on examples in which A3 size printing paper is made A4 size by being folded in half as extended printing paper, but it is also possible, for example, to use A2 size printing paper made A4 size by being folded in half twice, and after one automatic double-sided printing, to fold back the second fold toward the opposite side, making the unprinted side the surface, and perform automatic double-sided printing once again. In this case, A2 size printing is possible with an A4 size printer.

### Embodiment 4

(Description of Extended Printing Paper)

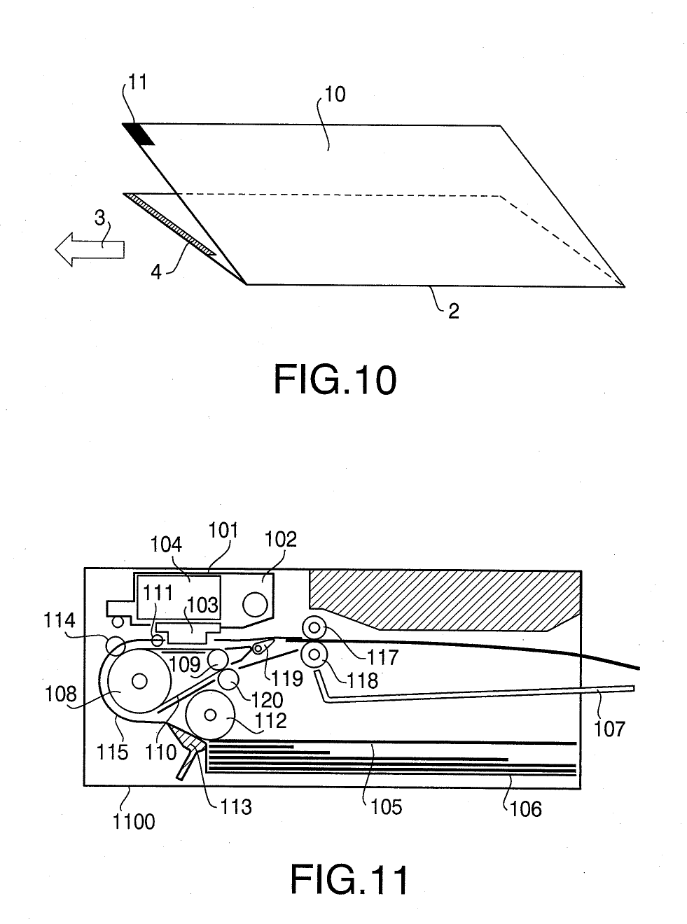

FIG. 10 shows an example of printing paper that is desirable for use in a printing method or printing apparatus according to Embodiment 4 of the present invention (hereinafter referred to as “extended printing paper”) 10. This extended printing paper 10 is A3 size paper folded in the middle, creating a fold 2. A mark 11 visible to the naked eye is provided at the corner of this extended printing paper 10 on the side opposite the fold. Positioning the mark here, at the corner of an A3 image, enables any affect on the image to be kept comparatively minor. Mark 11 is positioned so as to be in the kind of fixed positional relationship to fold 2 shown in FIG. 10. Folded in half, this extended printing paper 10 is inserted into a printing apparatus described later herein in the direction indicated by arrow 3—that is to say, if an operator inserts extended printing paper 10 so that mark 11 at the top-right, extended printing paper 10 will be set correctly.

In Embodiment 4, an adhesive layer 4 is preferably provided on part of a folded inner surface. This adhesive layer enables the upper and lower parts to be kept in close contact in the folded state, and to be handled just like a single sheet of paper inside the apparatus. Although this adhesive layer is firm with respect to shearing force, it can easily be peeled off depending on the pulling direction. A water-based acrylic adhesive or the like, for example, can be used as such an adhesive material.

Furthermore, a configuration may be used such that pressure is applied beforehand to the adhesive layer by means of a rubber adhesive to cause adhesion. With this configuration, once peeling-off is performed the adhesive effect is mostly lost, so that after printing the paper can be handled in the same way as A3 paper by opening it out. Also, this adhesive layer 4 may be applied to an entire inner surface if its adhesive strength is very weak. In particular, while a printing apparatus using an ink-jet recording method described later herein is described by way of example in Embodiment 4, if an electrophotographic type of printing apparatus such as described in a later embodiment is used, wrinkles are prone to occur in a fixing section that heat-fixes toner, and therefore it is desirable for the area of this adhesive layer to be fairly large.

In FIG. 10 of Embodiment 4, the edges of adhesive layer 4 are shown as being formed so as to coincide with the vertical and horizontal edges of paper 10, but in actuality it is desirable for a minute uncoated area of adhesive layer 4 to be provided at the edges. If adhesive layer 4 is provided up to the edges of paper 10, there is a possibility of adhesive being extruded due to pressure from a roller or the like during transportation inside the apparatus and adhering to members inside the apparatus, with detrimental results. When an electrophotographic printing apparatus is used, in particular, since high pressure is applied while also applying heat in the fixing unit in order to fix an image, there is a high probability of adhesive being extruded and adversely affecting members of the apparatus.

(Description of Printing Apparatus)

FIG. 11 is a cross-sectional side view of a printing apparatus according to Embodiment 4 of the present invention.

This printing apparatus 1100 can normally use printing paper up to A4 in size and uses an ink-jet recording method, and is provided with an automatic double-side mechanism that enables double-sided printing by reversing paper inside the apparatus. The basic configuration of printing apparatus 1100 is virtually the same as the configuration of printing apparatus 100 of Embodiment 1 described above, and includes print controller 150, operation panel section 170, paper transportation mechanism section 180, print mechanism section 101, and so forth, in printing apparatus 100 shown in FIG. 3.

As shown in FIG. 11, in printing apparatus 1100 an internal print mechanism section 101 comprises a carriage 102 that is movable in the main scanning direction (the paper surface depthwise direction in FIG. 11), a recording head 103 constituting the ink-jet head mounted on the carriage, an ink cartridge 104 that supplies ink to the recording head, and so forth.

Below, a paper feed cassette 106 that can hold many sheets of paper 105 can be freely inserted and removed from the front (the right-hand direction in FIG. 11). The apparatus draws in paper 105 fed from paper feed cassette 106, and after recording a predetermined image by means of print mechanism section 101, ejects paper 105 onto an ejection tray 107 provided above paper feed cassette 106.

In order to transport paper 105 in a sub-scan direction with respect to main scanning of recording head 103 in print mechanism section 101, a transport belt 110 that transports paper 105 by means of electrostatic adhesion is suspended between a first transport roller 108 and a second transport roller 109.

A front edge roller 111 that regulates the angle of transportation of paper 105 is located so as to press against first transport roller 108 via transport belt 110.

In order to feed paper 105 from paper feed cassette 106 onto transport belt 110, a paper feed roller 112 and a friction pad 113 that are pressed against each other are provided to separate and feed one sheet of paper 105 at a time, an intermediate roller 114 is provided that presses fed paper 105 against first transport roller 108, and a guide member 115 that guides paper 105 is also provided. Furthermore, in order to eject paper 105 for which printing has finished onto ejection tray 107, a guide member 116 that guides paper 105, an upper ejection roller 117, and a lower ejection roller 118, are provided.

As mechanisms for performing automatic double-sided printing, a guide lug 119 and reverse intermediate roller 120 are provided that, in order for paper 105 ejected by upper and lower ejection rollers 117 and 118 after printing of its surface until its rear edge is left to be drawn back again by the reversal of upper and lower ejection rollers 117 and 118, guide drawn-back paper 105 downward. These mechanisms make it possible for paper 105 to be reversed and undergo automatic double-sided printing.

(Description of Paper Extension Print Operation)

Next, an operation will be described for automatically performing printing on A3 size paper (hereinafter referred to as “paper extension printing”) using extended printing paper 10 and printing apparatus 1100.

When performing paper extension printing, as described above, the user sets extended printing paper 10 in paper feed cassette 106 of printing apparatus 100 in FIG. 11 so that the direction of arrow 3 in FIG. 10 is at the front edge by having mark 11 at the top-right. Printing apparatus 1100 is controlled in paper extension print mode by a paper extension print command from a computer (not shown) connected to this printing apparatus. Operation of printing apparatus 1100 starts, and one sheet of extended printing paper 10 is transported toward transport belt 110 through the agency of paper feed roller 112 and friction pad 113. At this time, extended printing paper 10 is in a state of being folded in half upon itself, and its edges are stuck together with adhesive, thereby having strong adhesive strength with respect to shearing force, so that it is transported just like a single sheet. In paper extension print mode, control may be performed so that the pressure between paper feed roller 112 and friction pad 113 is less than usual. At this time, the adhesive strength of adhesive layer 4 of extended printing paper 10 can be further reduced.

Paper feed cassette 106 may be replaced by a cassette specifically for paper extension printing that holds only one sheet of extended printing paper at a time, in which case control may be performed so that this friction pad 113 is disengaged and does not perform any action.

Extended printing paper 10 is transported by transport belt 110, and on reaching print mechanism section 101, one side of extended printing paper 10 is first printed.

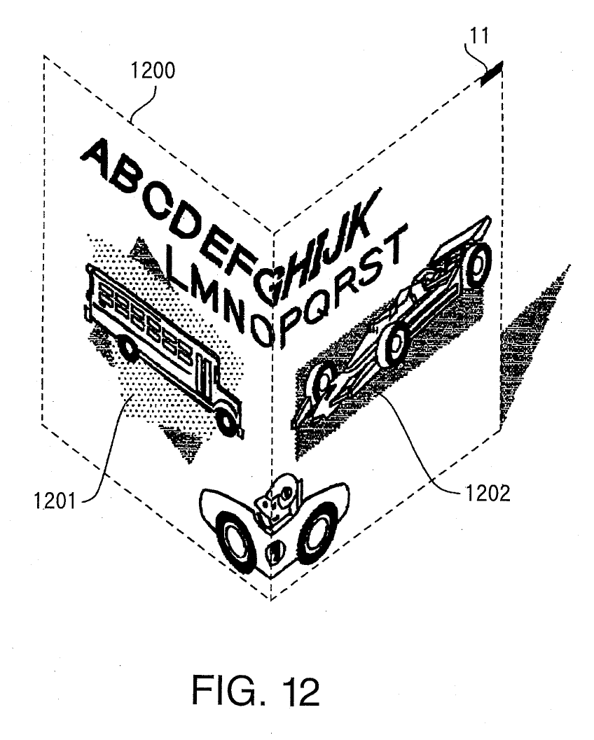

FIG. 12 shows the half-opened-out state of extended printing paper 1200 on which both sides have been printed to completion. In the first printing, the image on the first surface (the surface opposite the surface with a mark)—that is, surface 1201 in FIG. 12—is printed first. At this time, in the printing of surface 1201, printing is performed in order from the front edge (from the upper part of FIG. 12) by main scanning of recording head 103 and sub-scan direction transportation of extended printing paper 10 synchronized therewith.

Returning to FIG. 11 again, the front edge of extended printing paper 10 whose first surface has been printed is transported in the sub-scan direction, and reaches guide lug 119. As guide lug 119 is only lightly sprung in an anticlockwise direction about its rotation axis, the front edge of extended printing paper 10 pushes this guide lug aside and reaches upper and lower ejection rollers 117 and 118, and driven by the rotation of these rollers, further proceeds toward the ejection tray.

When the first surface has been completely printed, and the rear edge of extended printing paper 10 has been transported as far as the vicinity of upper and lower ejection rollers 117 and 118, upper and lower ejection rollers 117 and 118 start reversing, and extended printing paper 10 is transported again in the direction of transport belt 110. Since guide lug 119 is in the position shown in FIG. 11 at this time, extended printing paper 10 enters the lower path, and is again transported, driven by transport belt 110 and reverse intermediate roller 120.

What is printed by print mechanism section 101 at this time is the second surface (the surface with a mark) of extended printing paper 10—that is, surface 1202 in FIG. 12. The lateral-direction positions of the images printed on the respective surfaces are controlled by print controller 150 so as to be connected at the fold.

Printing of the second surface is performed from the rear edge (from the lower part of FIG. 12). Therefore, the image printing start position from the edge of extended printing paper 10 is controlled by print controller 150 so that the images printed on the respective surfaces are connected at the fold.

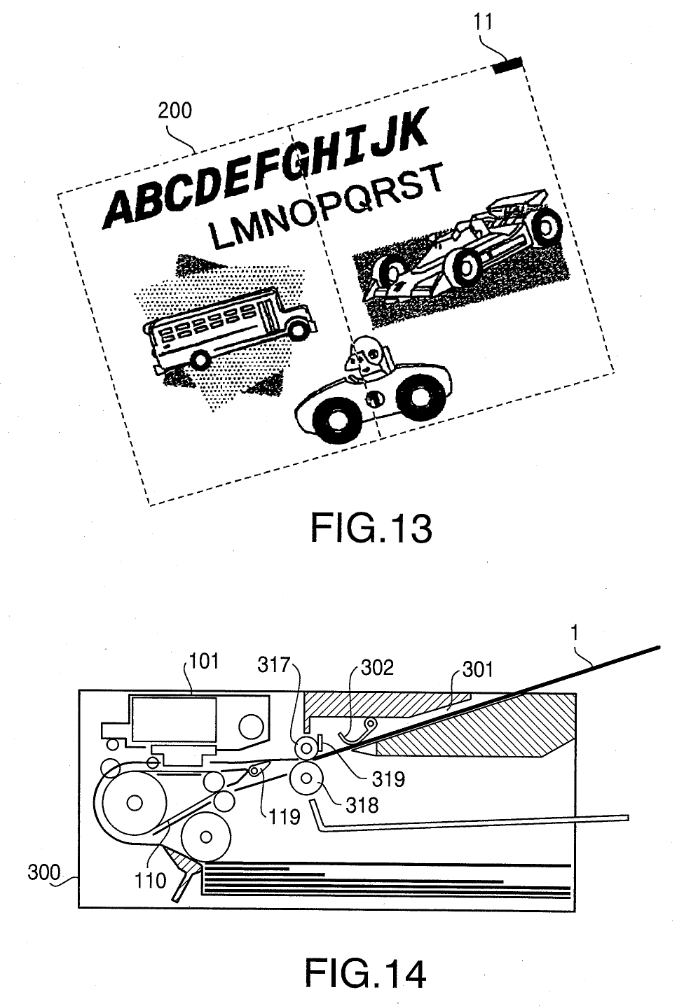

FIG. 13 shows previously folded extended printing paper 1200 opened out and used as an A3 image after being printed to completion.

This concludes a description of an operation for automatically performing printing on A3 paper using extended printing paper 10 and printing apparatus 1100.

### Embodiment 5

Next, a description will be given of printing paper, a printing method, and a printing apparatus according to Embodiment 5 of the present invention. In the following description, descriptions of parts having the same configuration or performing the same operation as in Embodiment 4 are omitted, and elements having the same function are assigned the same reference numbers.

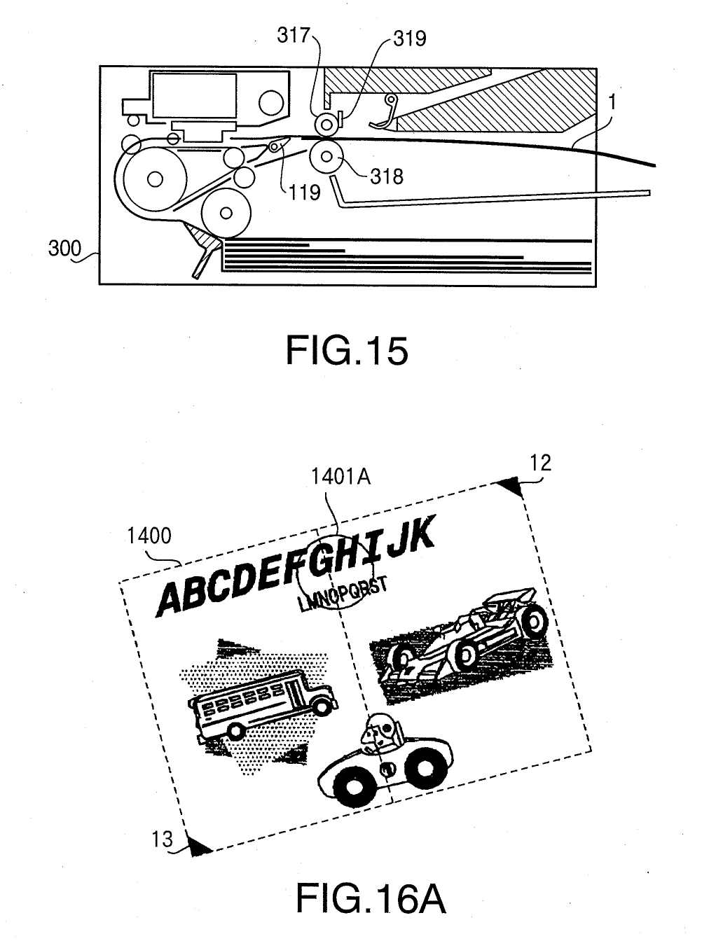

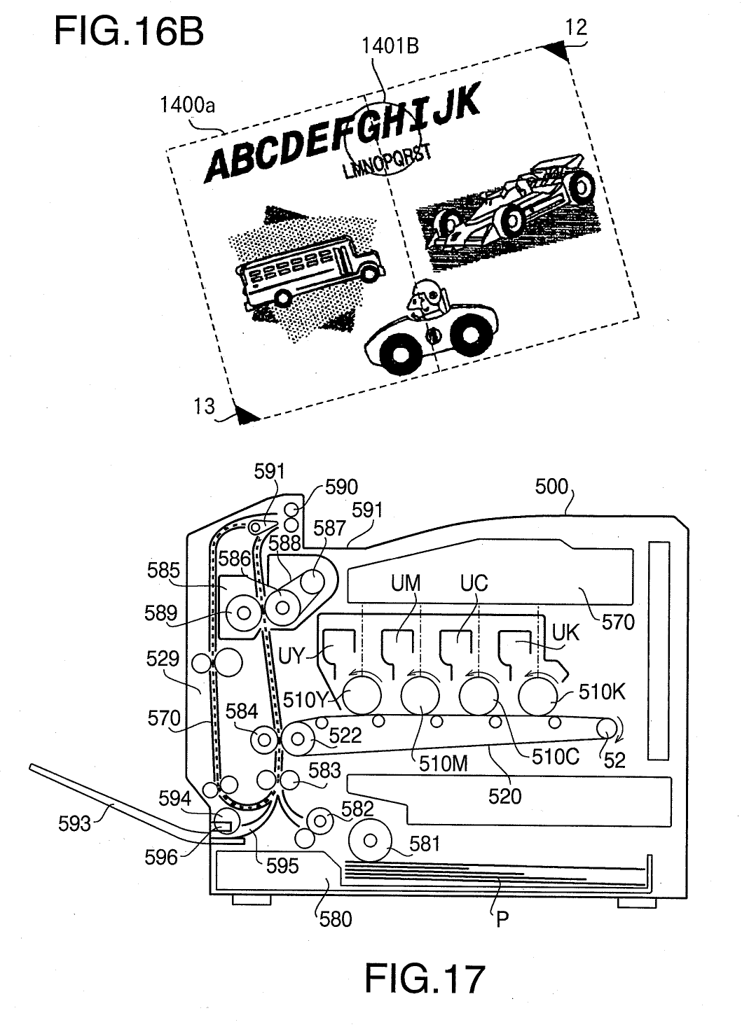

FIG. 14 and FIG. 15 are cross-sectional side views of a printing apparatus according to Embodiment 5 of the present invention. In this embodiment, a printing apparatus 1300 is equipped with a special paper feed aperture 301 for extended printing paper, for paper extension printing. Extended printing paper used at this time is shown as extended printing paper 1400 and 1400a opened out after being printed to completion in FIG. 16A and FIG. 16B. That is to say, marks 12 and 13 of the same shape are provided at the top-right corner and the bottom-left corner of this paper with respect to the fold.

When performing paper extension printing, the user sets extended printing paper 1400, in a pre-printing folded state, in special paper feed aperture 301 as shown in FIG. 14 so that the front edge comes up against upper and lower ejection rollers 317 and 318.

Returning to FIG. 14 again, the direction in which extended printing paper 1400 is set in the apparatus is such that it is inserted with a mark at the top-right as viewed by the operator, in the same way as in Embodiment 4. In this case, the surface bearing mark 12 or the surface bearing mark 13 in FIG. 16 may be uppermost. In either case, the fold is on the left with respect to the direction of insertion as viewed by the operator.

Lower ejection roller 318 has a larger diameter than upper ejection roller 317 so that the front edge of extended printing paper 1400 tends to hit it, and extended printing paper 1400 is readily drawn in by its subsequent rotation. A detection lever 302 and an extended paper sensor 319 are located at the rear of special paper feed aperture 301. When extended printing paper 1400 is set as shown in FIG. 14, extended printing paper 1400 is determined to have been set correctly through detection of the fact that paper of some kind has been set by a paper presence sensor (not shown) linked to detection lever 302, and detection of mark 12 or mark 13 by extended paper sensor 319, and printing apparatus 1300 enters paper extension print mode.

When a print command is issued from a computer (not shown) connected to this printing apparatus in this state, a paper extension print operation starts.

First, upper and lower ejection rollers 317 and 318 start rotating in a direction such that extended printing paper 1400 is drawn into the apparatus, and extended printing paper 1400 is drawn in. At this time, since upper and lower ejection rollers 317 and 318 have no function for handling paper one sheet at a time as with the normal paper feed section below, there is no obstruction to transportation even if the adhesive strength of adhesive on the folded inner surfaces of extended printing paper 1400 is extremely weak, or even if no adhesive layer is provided.

The front edge of drawn-in extended printing paper 1400 is guided by upward-sprung guide lug 119 in the same way as in Embodiment 4 and enters the lower path, and is transported to print mechanism section 101 by transport belt 110 and the same kind of peripheral members as in Embodiment 4, where the first surface is printed. The operations after printing are the same as in Embodiment 4.

FIG. 15 shows the state in which printing of the first surface has finished, and the front edge of extended printing paper 10 has reached the vicinity of upper and lower ejection rollers 317 and 318. At this time, upper and lower ejection rollers 317 and 318 start reversing, extended printing paper 400 is drawn into the apparatus once again, and printing of the second surface is performed in the same way as in Embodiment 4.

This concludes a description of printing paper, a printing method, and a printing apparatus according to Embodiment 5 of the present invention. In Embodiment 5, a paper feed aperture specifically for paper extension printing is provided, so that a mechanism for single sheet separation is not necessary in the paper feed section, and therefore an adhesive layer of a folded part of extended printing paper 1400 is unnecessary, or may be of extremely weak adhesive strength.

### Embodiment 6

Next, a description will be given of a printing method and printing apparatus according to Embodiment 6 of the present invention. In Embodiment 6, when a small character, specifically, lies on the fold of extended printing paper 10, control is performed so that printing is performed with the character position shifted.

FIG. 16A shows a result of printing when normal printing is performed without performing this kind of control. In the area denoted by reference code 1401A, even though a large character in the upper line (here, the character “G”) lies on the fold, this is not much of a problem, whereas a small character in the lower line (here the character “O”) lying on the fold may be difficult to distinguish and misread.

In Embodiment 6, if a character of a predetermined size or smaller is positioned on the fold in normal printing, control is performed so that the entire line containing that character is shifted sideways until a space between characters lies on the fold, as shown in the area denoted by reference code 1401B in FIG. 16B, before printing is performed. To be specific, print control is performed so that, in FIG. 16(B), character “O” is moved away from the fold, and the fold is positioned at the space between character “O” and character “P”. Instead of shifting the entire line at this time, nearby character spacing may be adjusted little by little so that the character in question is moved away from the fold.

This concludes a description of a printing method and printing apparatus according to Embodiment 6 of the present invention.

With Embodiment 6, when extended printing paper 10 is opened out and viewed in its entirety after printing, small characters, specifically, are clearly visible since they do not lie on the fold, and misidentification of characters can be prevented.

In Embodiment 6, an example has been described in which, when a small character lies on the fold, its position is shifted away from the fold so that there is no interference with character recognition. In other situations in which printing becomes unstable due to overlapping of the fold, other than by a character, such as in the case of dots or ruled lines in the vicinity of the fold, the same kind of effect is produced by execution as necessary. In particular, if vertical ruled lines are near the fold and are left as they are, there may be a tendency for ruled lines not to be printed or to be discontinuous due to a minute positional displacement or the like.

In above Embodiments 4 through 6, descriptions have centered on examples in which double-sided printing is performed using an ink-jet type of printing apparatus, but the present invention can also achieve the same kind of effects when using a printing apparatus that has an automatic double-sided printing function employing an electrophotographic recording method.

In the above embodiments, descriptions have centered on examples in which A3 size printing paper is made A4 size by being folded in half as extended printing paper, but it is also possible, for example, to use A2 size printing paper made A4 size by being folded in half twice, and after one automatic double-sided printing, to fold back the second fold toward the opposite side, making the unprinted side the surface, and perform automatic double-sided printing once again. In this case, A2 size printing is possible with an A4 size printer.

### Embodiment 7

Next, a description will be given of a printing method and printing apparatus according to Embodiment 7 of the present invention. In Embodiment 7, the present invention is applied to a color laser printer capable of up to A4 size printing that uses an electrophotographic method and is employed in an office as a printing apparatus.

(Description of Printing Apparatus)

FIG. 17 is a schematic configuration diagram of an A4 color laser printer 1500 that is a printing apparatus used in Embodiment 7 of the present invention. The configuration and normal print operation of this color laser printer 1500 are described below.

Color laser printer 1500 according to this embodiment employs a method whereby toner images of four colors contributing to the coloring of a color image are formed individually on four image bearing elements, the toner images of the image bearing elements are successively superimposed onto an intermediate transfer element as a primary transfer process, after which blanket transfer (secondary transfer) of this primary transfer image is performed to a recording medium, forming a color image.

In FIG. 17, symbols Y, M, C, and K appended to the reference codes assigned to various configuration elements of color laser printer 1500 indicate configuration elements involved in formation of a yellow image (Y), magenta image (M), cyan image (C), and black image (K), respectively, with configuration elements assigned the same reference code having a common configuration.

As shown in FIG. 17, color laser printer 1500 has four photosensitive drums 510Y, 510M, 510C, and 510K as the above-described image bearing elements, and an intermediate transfer belt 520 as the above-described intermediate transfer element. Around photosensitive drums 510Y, 510M, 510C, and 510K are located image forming units UY, UM, UC, and UK, respectively, for forming toner images of the respective colors individually.

Image forming units UY, UM, UC, and UK are provided individually with an electrifier, developing unit, cleaning apparatus, and so forth (not shown).

In FIG. 17, each of photosensitive drums 510Y, 510M, 510C, and 510K is rotated in the direction indicated by the arrow, and the surfaces of photosensitive drums 510Y, 510M, 510C, and 510K are uniformly charged to a predetermined potential by their respective electrifiers (not shown).

The surfaces of charged photosensitive drums 510Y, 510M, 510C, and 510K are irradiated with laser beam scanning lines corresponding to image data of specific colors by means of an aligner (exposure apparatus) 570.

By this means, electrostatic latent images of the aforementioned specific colors are formed on the surfaces of photosensitive drums 510Y, 510M, 510C, and 510K.

The electrostatic latent images of each of the specific colors formed on photosensitive drums 510Y, 510M, 510C, and 510K are developed by means of toner of the respective colors supplied from developing units in image forming units UY, UM, UC, and UK respectively. By this means, unfixed toner images of the four colors contributing to the coloring of the color image are formed on photosensitive drums 510Y, 510M, 510C, and 510K.

The developed toner images of four colors on photosensitive drums 510Y, 510M, 510C, and 510K successively undergo primary transfer to intermediate transfer belt 520 at predetermined timing by means of transfer sections (not shown). By this means, the toner images of four colors formed on photosensitive drums 510Y, 510M, 510C, and 510K are successively superimposed, and a full-color image is formed on intermediate transfer belt 520.

After the toner images have been transferred to intermediate transfer belt 520, photosensitive drums 510Y, 510M, 510C, and 510K have residual toner remaining on their surfaces removed by the cleaning apparatuses.

Intermediate transfer belt 520 is suspended over a drive roller 521 and idler roller 522, and is circulated in the direction indicated by the arrow in FIG. 17 by rotation of drive roller 521.

At the bottom of color laser printer 1500, a paper feed cassette 580 is provided in which A4 or smaller printing paper P is held. Printing paper P is sent out from paper feed cassette 580 by means of a paper feed roller 581 one sheet at a time into a predetermined sheet path.

Printing paper P sent out into this sheet path is fed toward registration rollers 583 by a transport roller 582, and paper feeding is stopped temporarily with the front edge of printing paper P held in the nip of registration rollers 583.

Printing paper P held between registration rollers 583 is re-fed by the rotation of registration rollers 583 at timing at which the front edge of the image formation area of printing paper P and the front edge of the full-color image formed on intermediate transfer belt 520 coincide.

Re-fed printing paper P is transported so as to pass through a transfer nip formed between the outer surface of intermediate transfer belt 520 suspended on idler roller 522 and a secondary transfer roller 584 in contact with the outer surface of intermediate transfer belt 520.

By this means, when printing paper P passes through the transfer nip, the full-color image formed on intermediate transfer belt 520 undergoes blanket transfer (secondary transfer) onto printing paper P by secondary transfer roller 584.

Printing paper P to which the full-color image (unfixed image) has been blanket-transferred is transported so as to pass through a fixing nip formed between the outer surface of a fixing belt 588 suspended over a fixing roller 586 and heating roller 587, and a pressure roller 589 that drives fixing belt 588 around through contact.

In this way, the unfixed full-color image blanket-transferred by means of the transfer nip is heat-fixed onto printing paper P by means of the fixing nip. Printing paper P to which this full-color image has been heat-fixed is ejected onto an ejection tray 591 by ejection rollers 590.

This color laser printer is also equipped with an automatic double-side function. When image forming is also performed on the rear surface of printing paper P using this function, printing paper P on which a full-color image has been heat-fixed by a normal operation begins to be ejected by ejection rollers 590. When the rear edge of printing paper P comes between ejection rollers 590, ejection rollers 590 reverse and draw printing paper P into the apparatus once again. Since a switching lug 591 is forced into the position shown in FIG. 17 at this time, printing paper P passes through a double-side transportation path 592 and is transported to the nip of registration rollers 583 with its front and rear surfaces reversed. Thereafter, in the same way as in a normal operation, an image is transferred from intermediate transfer belt 520 to the rear surface and heat-fixed again, and then printing paper P is ejected onto ejection tray 591.

When printing paper P is fed manually, printing paper P placed on a manual paper feed tray 593 is transported by means of a manual paper feed roller 594 to the nip of registration rollers 583 via a manual paper feed path 595. Thereafter, a print operation is performed in the same way as before.

An extended paper sensor 596 for detecting mark 12 or 13 of extended printing paper 1400 is located toward the front in the paper surface depthwise direction of this manual paper feed tray 593, and when extended printing paper is set on the manual paper feed tray, this extended paper sensor 596 can detect the orientation of the extended printing paper from the presence or absence of a mark.

Since the position and pattern of adhesive layer 4 are assumed to be approximately fixed on extended printing paper 1, extended paper sensor 596 may be an image sensor that can detect a 1-dimensional or 2-dimensional pattern by detecting transmitted light when light is shone on paper 105, and may be able to detect the position of adhesive layer 4 on extended printing paper 1 after the pattern is recognized by print controller 150. By this means, with printing apparatus 100, restrictions on the orientation of extended printing paper 1 when set by a user in paper feed cassette 106 are eliminated, simplifying paper handling, and paper extension printing losses can be prevented.

This concludes a description of the configuration and normal print operation of this color laser printer 1500.

(Description of Paper Extension Print Operation)

Next, an operation will be described for performing paper extension printing using this color laser printer 1500.

When paper extension printing is performed on A3 paper using this color laser printer 1500, extended printing paper 1400 in FIG. 16 used in Embodiment 5 is employed. Unprinted, folded extended printing paper 1400 is placed on manual paper feed tray 593 of printing system 500 in FIG. 17.

When extended paper sensor 596 detects the presence of mark 12 or mark 13 while current detection section 140 is so set, it is known that extended printing paper 1400 has been set with the fold on the left looking in the direction of insertion, the same as that indicated by arrow 3 in FIG. 10 in Embodiment 4. Conversely, if the presence of a mark is not detected, extended printing paper 1400 is determined to have been set with the fold on the right. With this embodiment, extended printing can be performed automatically irrespective of which of these setting orientations is used.

When, in this state, a print command is input from a personal computer connected to this color laser printer 1500 after paper extension print mode has been selected by the user, extended printing paper 10 placed on manual paper feed tray 593 is selected automatically and paper feeding is started. In this paper extension print mode, the print operation is set automatically so that above-described automatic double-sided printing is performed.

Also, in this mode, irrespective of the orientation with which above-described extended printing paper 1400 is set, the relationship between the images printed on the front and rear surfaces is set so that printing is always performed based on the relationship described in Embodiment 4 with respect to the fold, and the printing order is selected so that the final printed image is as shown in FIG. 12.

That is to say, when a mark has been detected, image forming is first performed so that the image on the left-hand surface in FIG. 16A is positioned as in FIG. 16A, and is transferred by means of a part of secondary transfer roller 584. In this case, the positional relationship of the image in the vertical direction is coordinated by synchronizing the timing at which the image formed on intermediate transfer belt 520 is brought along with the timing at which feeding is started by registration rollers 583. Then, after this image has been fixed, when it is reversed by an automatic double-side operation, the image on the right-hand surface in FIG. 16 is transferred with the positional relationship shown in FIG. 16A.

If, conversely, a print command is issued after paper extension print mode has been selected when a mark has not been detected, control is performed so that the image first formed and transferred is the right-hand image in FIG. 16A. Then reversal is performed by an automatic double-side operation, and the left-hand image in FIG. 16A is formed on the rear side. Therefore, irrespective of which of the two orientations is used in setting extended printing paper 1400, image forming is performed at the correct position with respect to the fold.

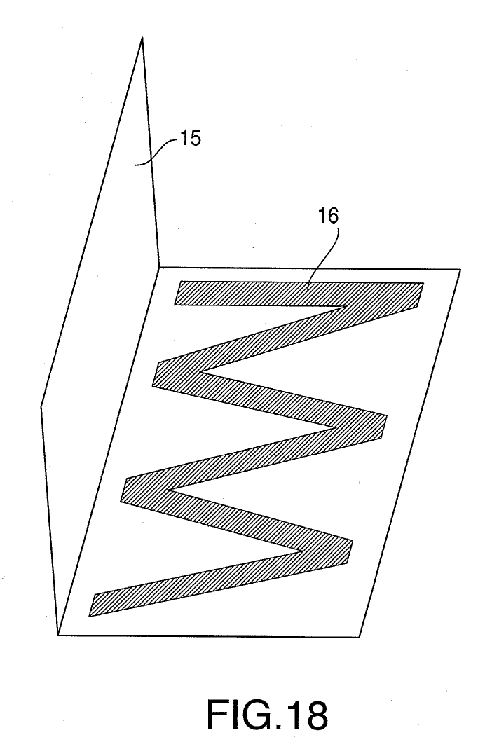

With extended printing paper 10 in FIG. 10 an example is shown in which adhesive layer 4 is provided only on the front edge, but in this embodiment an adhesive layer may be further provided on the entire meeting surfaces. According to an experiment by the inventors, if an adhesive layer is not present over a wide area, wrinkles may be prone to occur after fixing with an ordinary apparatus. Therefore, as a countermeasure to this, it is desirable for an adhesive layer to be provided in a dispersed fashion over the entire surface. For example, it was found that wrinkles due to fixing tend not to occur if an adhesive layer is provided over the entire surface, although in a dispersed fashion, as in the case of adhesive layer 16 of extended printing paper 15 in FIG. 18.

In further experimental trials by the inventors, there were cases with this kind of electrophotographic printing apparatus, and particularly with a halftone or suchlike image, in which, depending on the conditions, the pattern appeared slightly different in parts with and without an adhesive layer. It is supposed that, when an image is transferred from the intermediate transfer belt, if there is a mix of a part where there is an adhesive layer and the two leaves are in close contact, and a part where there is no adhesive layer and there is a layer of air between the two leaves, a difference in electrostatic characteristics may occur between the two due to the transfer conditions. In this regard, an effect of increasing the margin for maintaining high image quality is achieved by filling gaps to a greater extent than in FIG. 18 and providing an adhesive layer on virtually the entire surface, or applying very small dot-shaped adhesive layers to the entire surface. However, even in such cases, it is desirable for parts with no adhesive layer to be provided at the top, bottom, left, and right edges of the paper in order to prevent adhesive being extruded and affecting the apparatus.

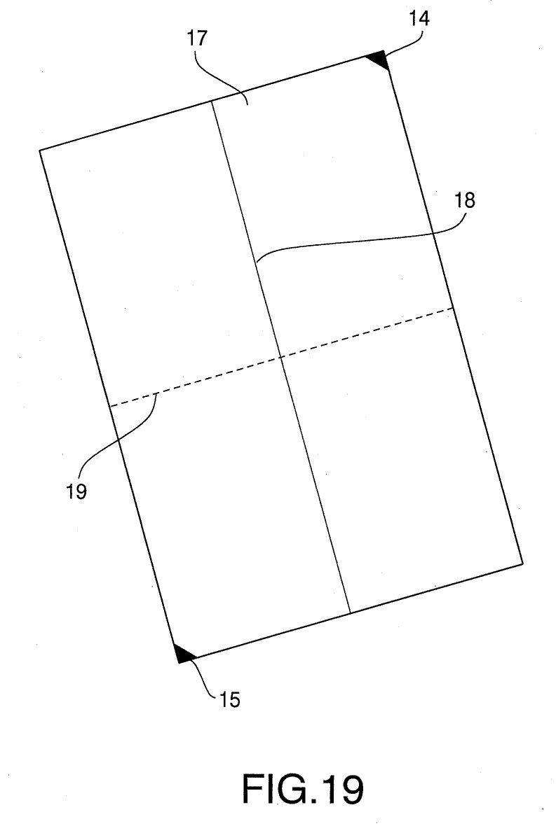

Next, an operation will be described for performing A2 paper extension printing with this embodiment. FIG. 19 shows A2 extended printing paper 17 used for this purpose, with an overall size of A2. This A2 extended printing paper 17 is folded along its vertical center as indicated by solid line 18 in FIG. 19, so that its horizontal width is equal to the A4 short-direction width. Details regarding marks 14 and 15 are the same as in the case of previously described A3 extended printing paper 1400. Dashed line 19 in FIG. 19 is a virtual line for indicating A4 size, and does not indicate that the paper is folded along this line. (Details of the adhesive layer are the same as for A3 extended printing paper, and are omitted here.)

Extended printing paper 17 is inserted in the folded state into manual paper feed tray 593 in FIG. 17 in the same way as in above-described paper extension printing, and double-sided printing is performed automatically in the same way as in the case of A3 paper. At this time, A2 extended printing paper 17 is reversed at ejection rollers 590 as explained in the above-described automatic double-sided print operation, and goes to the secondary transfer section once again via double-side transportation path 592. At this time, the length of the transportation path part indicated by dashed line 570 in FIG. 17 is approximately equal to the lengthwise length of ordinary A2 paper. That is to say, the length of the transportation path from switching lug 591 via double-side transportation path 592, registration rollers 583, and secondary transfer roller 584, back to switching lug 591 again is made greater than the lengthwise length of A2 paper. Therefore, even when an automatic double-side operation such as described above is performed with A2 extended printing paper, the rear edge and front edge of the A2 extended printing paper do not overlap and cause a transportation problem at ejection rollers 590 or switching lug 591.

According to this method, since printing can be performed in a single operation, operability is simpler than when A2 paper is folded twice to achieve A4 size and two paper extension printing operations are performed, as described in Embodiment 6 above.

In above Embodiments 4 through 7, methods have been described in which adhesive is used to temporarily secure overlapping parts of extended printing paper, and is peeled off later, but the same kind of paper extension printing can also be performed by using paper whose edges are joined together in a folded state, and detaching the join part after printing.

Also, in above Embodiments 4 through 7, examples have been described in which a visible mark is formed on the surface of paper to indicate direction, but the paper may also be cut in the same kind of shape as marks 12 and 13 in FIG. 16, for example, so as to be visible to an operator or detectable by the apparatus. Furthermore, in Embodiments 5 through 7, an example of a mark visible to the naked eye was described, but a mark may also be used that is detectable only by the apparatus and cannot be recognized by a human being in order to affect the image as little as possible.

Also, in the above embodiments, descriptions have centered on examples of paper conforming to the “A” size standard, but it goes without saying that as long as paper has the same kind of size relationship, the same kind of effects can also be obtained with paper conforming to a different size standard, or not conforming to any standard.

A printing method according to a first aspect of the present invention performs image printing using printing paper of a size larger than that for which paper passage is possible for a printing apparatus by having: a step of preparing paper of a size larger than a size for which paper passage is possible for a printing apparatus used for printing; a step of folding this large-size paper one or more times to adjust the paper surface, thereby making a paper size for which paper passage is possible for the printing apparatus; a step of passing the paper that has been made a size for which paper passage is possible through the printing apparatus, and printing an image on both folded surfaces thereof; and a step of, after printing on both surfaces, unfolding the folded paper, and restoring it to the original large-size paper.

In a printing method according to a second aspect of the present invention, in the above aspect, printing on both surfaces is performed by a printing apparatus having a double-sided printing function with extended printing paper folded one or more times so as to be able to be opened out and viewed at a glance after printing.

According to these methods, printing can be performed on large printing paper by means of a small, inexpensive printing apparatus.

In a printing method according to a third aspect of the present invention, in an above aspect, in the step of printing an image, printing is performed with the relationship between a fold and the orientation or position of an image set so that when the paper is opened out image orientation and alignment are coordinated and at-a-glance viewing is possible.

According to this method, in addition to the effects of an above aspect being obtained, an image is easy to view at a glance after printing.

In a printing method according to a fourth aspect of the present invention, in an above aspect the extended printing paper has a page with an approximately A3 size paper surface folded.

According to this method, in addition to the effects of an above aspect being obtained, A3 printing can be performed by a printing apparatus whose maximum usable printing paper size is normally A4.

In a printing method according to a fifth aspect of the present invention, in an above aspect the extended printing paper has a page with an approximately A2 size paper surface folded twice.

According to this method, in addition to the effects of an above aspect being obtained, A2 printing can be performed by means of a printing apparatus whose maximum usable printing paper size is normally A4.

In a printing method according to a sixth aspect of the present invention, in an above aspect the extended printing paper has part or all of overlapping parts temporarily adhering by means of an adhesive layer so as to be able to be opened out and viewed at a glance after printing.

According to this method, in addition to the effects of an above aspect being obtained, a problem such as mutual displacement of overlapping parts during paper feeding, transportation, or the like in the apparatus does not occur.

In a printing method according to a seventh aspect of the present invention, in an above aspect, when one character of print text impinges upon a fold of the extended printing paper in the original image, the print position of the character is shifted so that the fold is at a space between characters.

According to this method, in addition to the effects of an above aspect being obtained, a small character is easy to recognize after printing.

A printing method according to an eighth aspect of the present invention performs image printing using printing paper of a size larger than that for which paper passage is possible for a printing apparatus by having: a step of preparing paper of a size larger than a size for which paper passage is possible for a printing apparatus; a step of folding this large-size paper one or more times to adjust the paper surface, thereby making a paper size for which paper passage is possible for the printing apparatus; a step of inserting the paper that has been made a size for which paper passage is possible and that has a mark in a fixed positional relationship to the fold into the printing apparatus, and printing an image on both folded surfaces thereof; and a step of, after printing on both surfaces, unfolding the folded paper, and restoring it to the original large-size paper.

In a printing method according to a ninth aspect of the present invention, in the above aspect, printing on both surfaces is performed by a printing apparatus having a double-sided printing function with extended printing paper that has a fold from being folded one or more times so as to be able to be opened out and viewed at a glance after printing and that has a mark on the paper in a fixed positional relationship to the fold.

According to these methods, printing can be performed on large printing paper by means of a small, inexpensive printing apparatus.

In a printing method according to a tenth aspect of the present invention, in an above aspect, in the step of printing an image, printing is performed with the relationship between the mark and the orientation or position of an image set so that when the paper is opened out image orientation and alignment are coordinated and at-a-glance viewing is possible.

According to this method, in addition to the effects of an above aspect being obtained, an image is easy to view at a glance after printing.

In a printing method according to an eleventh aspect of the present invention, in an above aspect, in the step of printing an image, printing is performed with the relationship between a fold and the orientation or position of an image set by detecting the presence or absence of the mark.

According to this method, since printing is performed automatically so that when the paper is opened out image orientation and alignment are coordinated and at-a-glance viewing is possible, a desired image can be printed on large printing paper by means of a simple operation.

A printing apparatus according to a twelfth aspect of the present invention employs a configuration that includes: a printing section that prints an image based on print data on one surface of paper including extended printing paper folded one or more times so as to be able to be opened out and viewed at a glance after printing; a transport section that transports the paper to the printing section and can freely reverse the paper and transport it to the printing section; and a print control section that controls operation of the transport section and the printing section in a predetermined mode among a plurality of print modes as modes of printing in which an image based on the print data printed on the paper differs, and prints an image based on the print data on the paper; wherein the print modes include a paper extension print mode in which an image based on the print data is subjected to double-sided printing on the extended printing paper, and the print control section, in the paper extension print mode, divides an image based on the print data, and prints the divided images respectively on both surfaces of the extended printing paper serving as the paper.

According to this configuration, printing can be performed on large printing paper by means of a small, inexpensive printing apparatus.

A printing apparatus according to a thirteenth aspect of the present invention employs a configuration whereby, in the above configuration, the print control section, in paper extension print mode, sets the relationship between a fold and the orientation or position of print data printed so that when the extended printing paper is opened out image orientation and alignment are coordinated and at-a-glance viewing is possible.

According to this configuration, in addition to the effects of the above configuration being obtained, an image is easy to view at a glance after printing.

A printing apparatus according to a fourteenth aspect of the present invention employs a configuration whereby, in an above configuration, the transport section has a paper feed section having a paper handling function, and the print control section, in the paper extension print mode, controls the paper feed section, and disengages or relaxes the handling function.

According to this configuration, in addition to the effects of the above configuration being obtained, obstruction of paper feeding of extended printing paper is unlikely to occur.

A printing apparatus according to a fifteenth aspect of the present invention employs a configuration whereby, in an above configuration, the transport section has a paper feed section for normal printing and a paper feed aperture for the extended printing paper.

According to this configuration, in addition to the effects of an above configuration being obtained, obstruction of paper feeding of extended printing paper is unlikely to occur.

A printing apparatus according to a sixteenth aspect of the present invention employs a configuration whereby, in an above configuration, the transport section has a reversing apparatus for reversing paper and performing double-sided printing, and the print control section calculates the printing start position for the rear surface of the paper from the length of the paper or sub-scan direction length of set top and bottom unprinted areas for the transport section and the printing section, and performs control so as to perform double-sided printing.

According to this configuration, in addition to the effects of an above configuration being obtained, image connection at the fold can be performed accurately.

A printing apparatus according to a seventeenth aspect of the present invention employs a configuration whereby, in an above configuration, the print control section, in the paper extension print mode, shifts a character impinging upon a fold of the extended printing paper in an original image to a position away from the fold before printing, using the printing section.

According to this configuration, in addition to the effects of an above configuration being obtained, a small character is easy to recognize after printing.

A printing apparatus according to an eighteenth aspect of the present invention employs a configuration that includes: a printing section that prints an image based on print data on one surface of paper including extended printing paper that has a fold from being folded one or more times so as to be able to be opened out and viewed at a glance after printing and that has a mark on the paper in a fixed positional relationship to the fold; a transport section that transports the paper to the printing section and can freely reverse the paper and transport it to the printing section; and a print control section that controls operation of the transport section and the printing section in a predetermined mode among a plurality of print modes as modes of printing in which an image based on the print data printed on the paper differs, and prints an image based on the print data on the paper; wherein the print modes include a paper extension print mode in which an image based on the print data is subjected to double-sided printing on the extended printing paper, and the print control section, when the paper extension mode has been selected by the print mode selection section, divides an image based on the print data, and prints the divided images respectively on both surfaces of the extended printing paper serving as the paper.

According to this configuration, printing can be performed on large printing paper by means of a small, inexpensive printing apparatus.

A printing apparatus according to a nineteenth aspect of the present invention employs a configuration whereby, in an above configuration, the print control section, in paper extension print mode, performs printing with the orientational relationship of an image based on print data that is printed set with respect to the mark so that when the extended printing paper is opened out image orientation and alignment are coordinated and at-a-glance viewing is possible.

According to this configuration, in addition to the effects of the invention according to claim 5 being obtained, an image is easy to view at a glance after printing.

A printing apparatus according to a twentieth aspect of the present invention employs a configuration whereby, in an above configuration, printing is performed with the relationship between a fold and the orientation or position of an image set by detecting the presence or absence of the mark.

According to this configuration, in addition to the effects of the invention according to claim 6 being obtained, since printing is performed automatically so that when the paper is opened out image orientation and alignment are coordinated and at-a-glance viewing is possible, a desired image can be printed on large printing paper by means of a simple operation.

A printing apparatus according to a twenty-first aspect of the present invention employs a configuration that includes: a printing section that prints an image based on print data on one surface of paper including extended printing paper folded one or more times so as to be able to be opened out and viewed at a glance after printing; a transport section that transports the paper to the printing section and can freely reverse the paper and transport it to the printing section; and a print control section that controls operation of the transport section and the printing section in a predetermined mode among a plurality of print modes as modes of printing in which an image based on the print data printed on the paper differs, and prints an image based on the print data on the paper; wherein the plurality of print modes include: an extended print mode in which paper folded up so as to be able to be opened out is used, and an image based on print data is divided and printed on both surfaces of this paper, after which the paper is unfolded, whereby an image is aggregated and laid out on one surface of the paper; and a reduced print mode in which ordinary paper with no folding is used, and an image is reduced and printed on one surface of this paper.

According to this configuration, when large-size image data (A3 size) is printed on one surface of paper by means of a printing apparatus that uses small-size paper (A4 size) (an A4 paper printing apparatus), if reduced printout smaller than the original image is acceptable, ordinary reduced printing (the second print mode) may be performed using ordinary paper, whereas if it is wished to print the image larger than is the case with reduced printing, extended printing (the first print mode) may be performed using folded-up paper.

A printing apparatus according to a twenty-second aspect of the present invention employs a configuration that includes: a printing section that prints an image based on print data on one surface of paper including extended printing paper folded one or more times so as to be able to be opened out and viewed at a glance after printing; a transport section that transports the paper to the printing section and can freely reverse the paper and transport it to the printing section; and a print control section that controls operation of the transport section and the printing section in a predetermined mode among a plurality of print modes as modes of printing in which an image based on the print data printed on the paper differs, and prints an image based on the print data on the paper; wherein the plurality of print modes include: an extended print mode in which paper folded up so as to be able to be opened out is used, and an image based on print data is divided and printed on both surfaces of this paper, after which the paper is unfolded, whereby an image is aggregated and laid out on one surface of the paper; and a page division print mode in which a plurality of sheets of ordinary paper with no folding are used, and an image based on image data is divided and printed on one surface of these sheets of paper.

According to this configuration, when large-size image data is printed at the same magnification, for example, if dividing the image for printing on a plurality of pages is acceptable, page division printing (the third print mode) may be performed using ordinary paper, whereas if it is wished to print on one sheet of paper, extended printing (the first print mode) may be performed using folded-up paper.

A printing apparatus according to a twenty-third aspect of the present invention employs a configuration that includes: a printing section that prints an image based on print data on one surface of paper including extended printing paper folded one or more times so as to be able to be opened out and viewed at a glance after printing; a transport section that transports the paper to the printing section and can freely reverse the paper and transport it to the printing section; and a print control section that controls operation of the transport section and the printing section in a predetermined mode among a plurality of print modes as modes of printing in which an image based on the print data printed on the paper differs, and prints an image based on the print data on the paper; wherein the plurality of print modes include: an extended print mode in which paper folded up so as to be able to be opened out is used, and an image based on print data is divided and printed on both surfaces of this paper, after which the paper is unfolded, whereby an image is aggregated and laid out on one surface of the paper; and an automatic double-sided print mode in which ordinary paper with no folding is used, and an image based on image data is divided and printed on both surfaces of this paper.

According to this configuration, when large-size image data is printed at the same magnification on one sheet of paper, for example, if dividing the image for printing on both surfaces of the paper is acceptable, automatic double-sided printing (the fourth print mode) may be performed, whereas if it is wished for an image to be printed aggregated and laid out on one surface, extended printing (the first print mode) may be performed using folded-up paper.

Printing paper according to a twenty-fourth aspect of the present invention employs a configuration used in a printing method of an above aspect.

According to this configuration, printing paper can be provided that enables printing of a large area by means of a small, inexpensive printing apparatus.

Printing paper according to a twenty-fifth aspect of the present invention employs a configuration used in a printing apparatus with an above-described configuration.

According to this configuration, printing paper can be provided that enables printing of a large area by means of a small, inexpensive printing apparatus.

Printing paper according to a twenty-sixth aspect of the present invention employs, in an above configuration, a configuration of being folded one or more times and adhering temporarily so as to be able to be opened out and viewed at a glance after double-sided printing.

According to this configuration, in addition to the effects of an above configuration being obtained, printing paper can be provided that has high reliability with respect to paper feeding and transportation inside an apparatus.

Printing paper according to a twenty-seventh aspect of the present invention employs, in an above configuration, a configuration of being folded one or more times and adhering temporarily so as to be able to be opened out and viewed at a glance after double-sided printing.

According to this configuration, in addition to the effects of an above configuration being obtained, printing paper can be provided that has high reliability with respect to paper feeding and transportation inside an apparatus.

Printing paper according to a twenty-eighth aspect of the present invention employs a configuration used in a printing method of an above aspect.

According to this configuration, printing paper can be provided that enables printing of a large area by means of a small, inexpensive printing apparatus.

Printing paper according to a twenty-ninth aspect of the present invention employs a configuration used in a printing apparatus of an above aspect.

According to this configuration, printing paper can be provided that enables printing of a large area by means of a small, inexpensive printing apparatus.

Printing paper according to a thirtieth aspect of the present invention employs, in an above configuration, a configuration that has a fold from being folded one or more times so as to be able to be opened out and viewed at a glance after double-sided printing and that has a mark in a fixed positional relationship to the fold.

According to this configuration, in addition to the effects of the invention according to claim 8 being obtained, printing paper can be provided that enables a desired image to be printed on a large area by means of a simple operation.

Printing paper according to a thirty-first aspect of the present invention employs, in an above configuration, a configuration that has a fold from being folded one or more times so as to be able to be opened out and viewed at a glance after double-sided printing and that has a mark in a fixed positional relationship to the fold.

According to this configuration, in addition to the effects of the invention according to claim 8 being obtained, printing paper can be provided that enables a desired image to be printed on a large image plane by means of a simple operation.

A printing system according to a thirty-second aspect of the present invention has image information or image printing information as input and performs image printout based on that information, and employs a configuration that includes: a double-sided printing section that can print on both the front and rear surfaces of printing paper; and an information processing section that can process image information or image printing information and cause the double-sided printing section to perform image printing; wherein the information processing section divides into two an image taken as to be represented on one page in input image information or printing information, and causes the double-sided printing section to print one of those divisions on the front surface of printing paper and to print the other on the rear surface of the same printing paper.

According to this configuration, by dividing into two in the relevant printing system an image taken as to be represented on one page in input image information or printing information, and printing on the front surface and rear surface of printing paper, preprocessing relating to page division and so forth can be rendered unnecessary on the side on which that system is used.

A printing system according to a thirty-third aspect of the present invention employs a configuration whereby, in an above configuration, the information processing section makes the size of a page for which printing is performed larger than the size of printing paper on which that printing is performed.

According to this configuration, by making the size of a page for which printing is performed in the relevant system larger than the size of printing paper on which that printing is performed, that system can also be used for a printing size larger than the printing paper size.

A printing system according to a thirty-fourth aspect of the present invention employs a configuration whereby, in an above configuration, the information processing section employs an image which is divided and printed on the front surface and rear surface of printing paper by the same magnification on the front surface and rear surface of printing paper when one page of the image based on inputted information is printed on a surface.

According to this configuration, by taking an image that is divided and printed on the front surface or rear surface of printing paper to have been enlarged, printing an image represented on one page enlarged to a size exceeding the printing paper size of the relevant system can be performed without preprocessing on the side on which that system is used.

A printing system according to a thirty-fifth aspect of the present invention employs a configuration whereby, in an above configuration, the information processing section performs printing of an image onto the front surface and rear surface of printing paper with almost no margin on at least one edge of the printing paper.

According to this configuration, by dividing an image taken to be represented on one page in input image information or printing information in two in the relevant printing system, and printing on the front surface and rear surface of printing paper leaving no margin or a very slight margin on at least one edge of the printing paper, preprocessing relating to a print margin can be rendered unnecessary on the side on which that system is used.

A printing system according to a thirty-sixth aspect of the present invention employs a configuration whereby, in an above configuration, the information processing section performs printing of an image composed of a plurality of pixels onto the front surface and rear surface of printing paper so that, for at least one edge of the printing paper, in an area along and close to the edge, and in a direction orthogonal to the edge, pixels of the same color and density as nearby pixels applied to the area are continued across a section of the area as an extended image.

According to this configuration, by dividing an image taken to be represented on one page in input image information or printing information in two in the relevant printing system, and printing on the front surface and rear surface of printing paper, for at least one edge of the printing paper, in an area along and close to the edge, and in a direction orthogonal to the edge, pixels of the same color and density as nearby pixels applied to the area, continued across a section of the area as an extended image, even if there is a gap in printing at an edge of the printing paper, preprocessing that prevents image loss can be rendered unnecessary on the side on which that system is used.

A printing system according to a thirty-seventh aspect of the present invention employs a configuration that has, in an above configuration, a display apparatus that displays, aligned so as to be in mutual contact, images for which division is performed and printing on the front surface and rear surface of printing paper is performed by the information processing section.

According to this configuration, by having images for which division is performed and printing on the front surface and rear surface of printing paper is performed displayed on a display apparatus, aligned so as to be in mutual contact, those images for which printing is performed can be viewed and checked before printing by the relevant system.

A printing system according to a thirty-eighth aspect of the present invention employs a configuration whereby, in an above configuration, a plurality of image, figure, or character objects are included in an image represented on one page by the display apparatus, and the information processing section has an object adjustment section that adjusts the position of each object on the one page.

According to this configuration, by enabling the position of each object on one page to be adjusted, an operator can adjust the position of each object for an image for which division is performed and printing on the front surface and rear surface of printing paper is performed, and optimize the relationship between the position of each object and the division position in performing image division.

The present application is based on Japanese Patent Application No. 2004-372834 filed on Dec. 24, 2004, and Japanese Patent Application No. 2005-090918 filed on Mar. 28, 2005, entire content of which is expressly incorporated herein by reference.

### INDUSTRIAL APPLICABILITY

The present invention has an extremely great effect in enabling printing of a large area by means of a small, inexpensive apparatus in various kinds of printing, such as printing by means of an ink-jet recording method or electrophotographic recording method used in offices and the like.

1. A printing method that performs image printing using printing paper of a size larger than that for which paper passage is possible for a printing apparatus, by comprising:
a step of preparing paper of a size larger than a size for which paper passage is possible for a printing apparatus used for printing;
a step of folding this large-size paper one or more times to adjust a paper surface, thereby making a paper size for which paper passage is possible for the printing apparatus;
a step of passing the paper that has been made a size for which paper passage is possible through the printing apparatus, and printing an image on both folded surfaces thereof; and
a step of, after printing on both surfaces, unfolding the folded paper, and restoring that paper to original large-size paper.

2. A printing method whereby printing on both surfaces is performed by a printing apparatus having a double-sided printing function with extended printing paper folded one or more times so as to be able to be opened out and viewed at a glance after printing.

3. The printing method according to claim 1, wherein, in the step of printing an image, printing is performed with a relationship between a fold and an orientation or position of an image set so that when the paper is opened out image orientation and alignment are coordinated and at-a-glance viewing is possible.

4. The printing method according to claim 1, wherein the extended printing paper has a page with an approximately A3 size paper surface folded.

5. The printing method according to claim 1, wherein the extended printing paper has a page with an approximately A2 size paper surface folded twice.

6. The printing method according to claim 1, wherein the extended printing paper has part or all of overlapping parts temporarily adhering by means of an adhesive layer so as to be able to be opened out and viewed at a glance after printing.

7. The printing method according to claim 1, wherein, when one character of print text impinges upon a fold of the extended printing paper in an original image, a print position of a character is shifted so that the fold is at a space between characters.

8. A printing method that performs image printing using printing paper of a size larger than that for which paper passage is possible for a printing apparatus, by comprising:
a step of preparing paper of a size larger than a size for which paper passage is possible for a printing apparatus;
a step of folding this large-size paper one or more times to adjust a paper surface, thereby making a paper size for which paper passage is possible for the printing apparatus;
a step of inserting the paper that has been made a size for which paper passage is possible and that has a mark in a fixed positional relationship to the fold into the printing apparatus, and printing an image on both folded surfaces thereof; and
a step of, after printing on both surfaces, unfolding the folded paper, and restoring that paper to the original large-size paper.

9. A printing method whereby printing on both surfaces is performed by a printing apparatus having a double-sided printing function with extended printing paper that has a fold from being folded one or more times so as to be able to be opened out and viewed at a glance after printing and that has a mark on paper in a fixed positional relationship to the fold.

10. The printing method according to claim 8, wherein, in the step of printing an image, printing is performed with a relationship between the mark and an orientation or position of an image set so that when the paper is opened out image orientation and alignment are coordinated and at-a-glance viewing is possible.

11. The printing method according to claim 8, wherein, in the step of printing an image, printing is performed with a relationship between a fold and an orientation or position of an image set by detecting presence or absence of the mark.

12. A printing apparatus comprising:
a printing section that prints an image based on print data on one surface of paper including extended printing paper folded one or more times so as to be able to be opened out and viewed at a glance after printing;
a transport section that transports the paper to the printing section and can freely reverse the paper and transport the paper to the printing section; and
a print control section that controls operation of the transport section and the printing section in a predetermined mode among a plurality of print modes as modes of printing in which an image based on the print data printed on the paper differs, and prints an image based on the print data on the paper, wherein:
the print modes include a paper extension print mode in which an image based on the print data is subjected to double-sided printing on the extended printing paper; and
the print control section, in the paper extension print mode, divides an image based on the print data, and prints the divided images respectively on both surfaces of the extended printing paper serving as the paper.

13. The printing apparatus according to claim 12, wherein the print control section, in paper extension print mode, sets a relationship between a fold and an orientation or position of print data printed so that when the extended printing paper is opened out image orientation and alignment are coordinated and at-a-glance viewing is possible.

14. The printing apparatus according to claim 12, wherein:
the transport section has a paper feed section having a paper handling function; and
the print control section, in the paper extension print mode, controls the paper feed section, and disengages or relaxes the handling function.

15. The printing apparatus according to claim 12, wherein the transport section has a paper feed section for normal printing and a paper feed aperture for the extended printing paper.

16. The printing apparatus according to claim 12, wherein:
the transport section has a reversing apparatus for reversing paper and performing double-sided printing; and
the print control section calculates a printing start position for a rear surface of the paper from a length of the paper or a sub-scan direction length of set top and bottom unprinted areas for the transport section and the printing section, and performs control so as to perform double-sided printing.

17. The printing apparatus according to claim 12, wherein the print control section, in the paper extension print mode, shifts a character impinging upon a fold of the extended printing paper in an original image to a position away from the fold before printing, using the printing section.

18. A printing apparatus comprising:
a printing section that prints an image based on print data on one surface of paper including extended printing paper that has a fold from being folded one or more times so as to be able to be opened out and viewed at a glance after printing and that has a mark on paper in a fixed positional relationship to the fold;
a transport section that transports the paper to the printing section and can freely reverse the paper and transport the paper to the printing section; and
a print control section that controls operation of the transport section and the printing section in a predetermined mode among a plurality of print modes as modes of printing in which an image based on the print data printed on the paper differs, and prints an image based on the print data on the paper, wherein:
the print modes include a paper extension print mode in which an image based on the print data is subjected to double-sided printing on the extended printing paper; and
the print control section, in the paper extension mode, divides an image based on the print data, and prints divided images respectively on both surfaces of the extended printing paper serving as the paper.

19. The printing apparatus according to claim 18, wherein the print control section, in paper extension print mode, performs printing with an orientational relationship of an image based on print data that is printed set with respect to the mark so that when the extended printing paper is opened out image orientation and alignment are coordinated and at-a-glance viewing is possible.

20. The printing apparatus according to claim 18, wherein printing is performed with a relationship between a fold and an orientation or position of an image set by detecting presence or absence of the mark.

21. A printing apparatus comprising:
a printing section that prints an image based on print data on one surface of paper including extended printing paper folded one or more times so as to be able to be opened out and viewed at a glance after printing;
a transport section that transports the paper to the printing section and can freely reverse the paper and transport the paper to the printing section; and
a print control section that controls operation of the transport section and the printing section in a predetermined mode among a plurality of print modes as modes of printing in which an image based on the print data printed on the paper differs, and prints an image based on the print data on the paper,
wherein the plurality of print modes include:
an extended print mode in which paper folded up so as to be able to be opened out is used, and an image based on print data is divided and printed on both surfaces of this paper, after which this paper is unfolded, whereby an image is aggregated and laid out on one surface of paper; and
a reduced print mode in which ordinary paper with no folding is used, and an image is reduced and printed on one surface of this paper.

22. A printing apparatus comprising:
a printing section that prints an image based on print data on one surface of paper including extended printing paper folded one or more times so as to be able to be opened out and viewed at a glance after printing;
a transport section that transports the paper to the printing section and can freely reverse the paper and transport the paper to the printing section; and
a print control section that controls operation of the transport section and the printing section in a predetermined mode among a plurality of print modes as modes of printing in which an image based on the print data printed on the paper differs, and prints an image based on the print data on the paper,
wherein the plurality of print modes include:
an extended print mode in which paper folded up so as to be able to be opened out is used, and an image based on print data is divided and printed on both surfaces of this paper, after which this paper is unfolded, whereby an image is aggregated and laid out on one surface of paper; and
a page division print mode in which a plurality of sheets of ordinary paper with no folding are used, and an image based on image data is divided and printed on one surface of these sheets of paper.

23. A printing apparatus comprising:
a printing section that prints an image based on print data on one surface of paper including extended printing paper folded one or more times so as to be able to be opened out and viewed at a glance after printing;
a transport section that transports the paper to the printing section and can freely reverse the paper and transport the paper to the printing section; and
a print control section that controls operation of the transport section and the printing section in a predetermined mode among a plurality of print modes as modes of printing in which an image based on the print data printed on the paper differs, and prints an image based on the print data on the paper,
wherein the plurality of print modes include:
an extended print mode in which paper folded up so as to be able to be opened out is used, and an image based on print data is divided and printed on both surfaces of this paper, after which this paper is unfolded, whereby an image is aggregated and laid out on one surface of paper; and
an automatic double-sided print mode in which ordinary paper with no folding is used, and an image based on image data is divided and printed on both surfaces of this paper.

24. Printing paper used in the printing method according to claim 1.

25. Printing paper used in the printing apparatus according to claim 12.

26. The printing paper according to claim 24, folded one or more times and adhering temporarily so as to be able to be opened out and viewed at a glance after double-sided printing.

27. The printing paper according to claim 25, folded one or more times and adhering temporarily so as to be able to be opened out and viewed at a glance after double-sided printing.

28. Printing paper used in the printing method according to claim 8.

29. Printing paper used in the printing apparatus according to claim 18.

30. The printing paper according to claim 28, wherein the printing paper has a fold from being folded one or more times so as to be able to be opened out and viewed at a glance after double-sided printing and that has a mark in a fixed positional relationship to the fold.

31. The printing paper according to claim 29, wherein the printing paper has a fold from being folded one or more times so as to be able to be opened out and viewed at a glance after double-sided printing and that has a mark in a fixed positional relationship to the fold.

32. A printing system that has image information or image printing information as input and performs image printout based on that information, comprising:
a double-sided printing section that can print on both front and rear surfaces of printing paper; and
an information processing section that can process image information or image printing information and cause the double-sided printing section to perform image printing,
wherein the information processing section divides into two an image taken as to be represented on one page in input image information or printing information, and causes the double-sided printing section to print one of those divisions on a front surface of printing paper and to print the other on a rear surface of the same printing paper.

33. The printing system according to claim 32, wherein the information processing section makes a size of a page for which printing is performed larger than a size of printing paper on which that printing is performed.

34. The printing system according to claim 32, wherein the information processing section employs an image which is divided and printed on the front surface and rear surface of printing paper by the same magnification on the front surface and rear surface of printing paper when one page of the image based on inputted information is printed on a surface.

35. The printing system according to claim 32, wherein the information processing section performs printing of an image onto a front surface and rear surface of printing paper with almost no margin on at least one edge of the printing paper.

36. The printing system according to claim 32, wherein the information processing section performs printing of an image composed of a plurality of pixels onto a front surface and rear surface of printing paper so that, for at least one edge of the printing paper, in an area along and close to the edge, and in a direction orthogonal to the edge, a pixel of the same color and density as a nearby pixel applied to the area is continued across a section of the area as an extended image.

37. The printing system according to claim 32, further comprising a display apparatus that displays, aligned so as to be in mutual contact, images for which division is performed and printing on a front surface and rear surface of printing paper is performed by the information processing section.

38. The printing system according to claim 37, wherein:
a plurality of image, figure, or character objects are included in an image represented on one page by the display apparatus, and;
the information processing section has an object adjustment section that adjusts a position of each object on the one page.
